(19) United States
(12) Patent Application Publication
(10) Pub. No.: US 2012/0173528 A1
(43) Pub. Date: Jul. 5, 2012

(54) SYSTEM AND METHOD FOR PROVIDING JOB SEARCH ACTIVITY DATA

(76) Inventor: Jonathan KREINDLER, Toronto (CA)

(21) Appl. No.: 13/339,172

(22) Filed: Dec. 28, 2011

Related U.S. Application Data
(60) Provisional application No. 61/428,069, filed on Dec. 29, 2010.

(51) Int. Cl. G06F 17/30

(52) U.S. Cl. 707/737; 707/E17.046

(57) ABSTRACT

One aspect of the invention provides system for facilitating a job search comprising a database, a display for displaying a user interface with past, present and future sections and one or more processors. The system stores job search data in the database, schedules one or more activities associated with the job search data and displays the job search data or one or more activities in one of the past, present and future sections. Also provided, in another aspect, is a reporting module operably connected to the database and configured to provide statistical data derived from the job search data and the one or more activities. A further aspect of the subject system is directed towards providing such data to third parties to facilitate coaching a job seeker and monitoring job search related activities.

### PRIORITY CLAIM

The present specification claims priority from U.S. Provisional Patent Application 61/428,069, having a filing date of Dec. 29, 2010, the contents of which are incorporated herein by reference.

### FIELD

The present specification relates generally to computer systems, and more particularly, a system and method for providing data about job search activity to a third-party.

### INTRODUCTION

Paper-based guides and ad-hoc spreadsheets created by career coaches, outplacement and recruitment agencies are often provided to job seekers in order to provide some regiment to an otherwise unstructured process. As a result, the job search process can traditionally be cumbersome and disorganized.

Also, with such systems, it can be difficult to inspect or monitor the activity of a job seeker. Neither the job seeker nor any concerned third party (e.g., government departments, educational institutions, outplacement coaches, etc.) can monitor the job search progress with any degree of accuracy.

There is thus a need for improved systems and methods for facilitating a job search, and for managing, measuring and monitoring the process of a job search.

### SUMMARY

The present invention provides, in one aspect, a server for managing data representing a job search project. The server comprises a memory and a processor; the memory for storing a master dataset representing the job search project and comprising a plurality of records, each record belonging to a category and including a task identifier. The processor is connected to the memory and configured to receive said master dataset from memory. The processor is further configured to determine a first dataset comprising a portion of records belonging to a first category, a second dataset comprising a portion of records belonging to a second category and a third dataset comprising a portion of records belonging to a third category. The processor is further configured to generate an output signal for controlling: a first region of a computer display for generating a first dataset graphical interface, a second region of a computer display for generating a second dataset graphical interface and a third region of a computer display for generating a third dataset graphical interface.

The present invention provides, in another aspect, a computer implemented method for managing data representing a job search project. The method comprises receiving a master dataset comprising a plurality of records. Each record belongs to a category and includes a task identifier and at least one editable data field. A first dataset comprises records belonging to a first category. A second dataset comprises records belonging to a second category. A third dataset comprises records belonging to a third category. A first region of a display is controlled for generating a first dataset graphical interface. A second region of a display is controlled for generating a second dataset graphical interface. A third region of a display is controlled for generating a third dataset graphical interface.

The present invention provides, in another aspect, a server for reporting data representing at least one job search project. The server comprises a memory and a processor; the memory for storing a plurality of master datasets, each master dataset representing a unique one of the job search projects and each said master dataset comprising a plurality of records. Each record belongs to a category and includes a task identifier and at least one editable field. The processor is connected to the memory and configured to receive the plurality of master datasets from memory. The processor is further configured to determine statistical data for each master dataset that includes a first aggregation of records within each respective master dataset where records belong to a first category, a second aggregation of records within each respective master dataset where records belong to a second category and a third aggregation of records within each respective master dataset where records belong to a third category. The processor is further configured to compile statistical data from each master dataset into a summary dataset and generate an output signal for controlling an output device to display at least a portion of the summary dataset.

The present invention provides, in another aspect, a computer-implemented method for reporting data representing at least one job search project. The method comprises receiving a plurality of master datasets, each master dataset representing a unique one of said job search projects and comprising a plurality of records. Each record belongs to a category and includes a task identifier and at least one editable field. For each master dataset, a first aggregation of records belonging to a first category, a second aggregation of records belonging to a second category and a third aggregation of records belonging to a third category are determined. A summary dataset is compiled from statistical data from each master dataset and an output device is controlled to display at least a portion of the summary dataset.

The present invention provides, in another aspect, a server for managing data representing a job search project. The server comprises a memory and a processor; the memory for storing a master dataset comprising a plurality of records representing the job search project. The processor is connected to the memory and configured to store the plurality of records in memory. Each record comprises at least one task identifier representing a type of task, at least one editable field associated with each task identifier and one of a first category, a second category and a third category.

The present invention provides, in another aspect, a computer-implemented method for managing data representing a job search project. The method comprises receiving at least one task identifier representing a type of task, defining at least one editable field associated with each task identifier and associating one of a first, second or third category with each task identifier. A record structure for a master dataset, comprising a plurality of records representing the job search project is defined where each record comprises a task identifier and its associated editable field and category.

### DRAWINGS

For a better understanding of the embodiments described herein and to show more clearly how they may be carried into effect, reference will now be made, by way of example only, to the accompanying drawings which show at least one exemplary embodiment, and in which:

FIG. 1 shows a system for managing data representing a job search project;

FIG. 2 shows a flow chart illustrating a computer-implemented method for configuring a job search project app;

FIG. 3 shows a flow chart illustrating a computer-implemented method for creating a job search project;

FIG. 4 shows a non-limiting example of a graphical interface that can be generated by a job search project app on the display of a client terminal;

FIG. 5 shows a non-limiting example of a graphical interface that can be generated by a job search project app on the display of a client terminal;

FIG. 6 shows a flow chart illustrating a computer-implemented method for configuring a job search project app;

FIG. 7 shows a flow chart illustrating a computer-implemented method for managing data representing a job search project;

FIG. 8 shows a non-limiting example of a graphical interface that can be generated by a job search project app on the display of a client terminal;

FIG. 9 shows a flow chart illustrating a computer-implemented method for reporting data representing a plurality of job search projects;

FIG. 10 shows a non-limiting example of an interface that can be generated by a job search project app on the display of a client terminal;

FIG. 11 is a schematic illustration of a system for facilitating a job search, in accordance with one embodiment of the present disclosure;

FIG. 12 is a flowchart diagram illustrating the steps of monitoring the progress of a job search, as may be performed by a career search supporter (whose services may be provided to a terminated employee by a former employer) of the job seeker;

FIG. 13 is a flowchart diagram illustrating the steps of monitoring the progress of a job search and providing constructive feedback to the end-user, as may be performed by an educational institution;

FIG. 14 is a flowchart diagram illustrating the steps of monitoring the progress of a job search, as may be performed by a government agency;

FIG. 15 illustrates an example of a job seeker User Activity report as may be provided to a third-party;

FIG. 16 is a flowchart diagram illustrating various steps for facilitating a job search as performed by one embodiment of the system described herein;

FIG. 17 is an example user interface of the system described herein, including past, present and future sections;

FIG. 18 is an illustration of a Past Activities page in the past section of an example user interface;

FIG. 19 is an illustration of a Future Activities page in the future section of an example user interface;

FIG. 20 is a Job Application record in the present section of an example user interface;

FIG. 21 is an illustration of the attachments tab of a Job Application record in the past section of an example user interface;

FIG. 22 is an illustration of the events tab of a Networking Event record in the future section of an example user interface;

FIG. 23 is an illustration of a search page allowing searching of activities associated with job search data in an example user interface;

FIG. 24 is an illustration of an example calendar page in an example user interface;

FIG. 25 is an illustration of an example contact list that can be populated with job search data (or may be automatically populated with job search data) in an example user interface;

FIG. 26 is an illustration of a Contact List and a search of the activities associated with a particular contact in an example user interface;

FIG. 27 is an illustration of an example news and resources page of an example user interface, as may be published by a group administrator;

FIG. 28 illustrates an example summary page of job search data;

FIG. 29 is an illustration of an example screenshot for downloading all documents for a job seeker in an example user interface;

FIG. 30 a flowchart diagram illustrating example steps performed by the system when creating a profile;

FIG. 31 is an illustration of the options of Job Applications and/or Networking in the first step of creating a new profile in an example user interface;

FIG. 32 is an illustration of setting Job Application targets when creating a new profile in an example user interface; and

FIG. 33 is an illustration of setting Networking targets when creating a new profile in an example user interface.

### DESCRIPTION

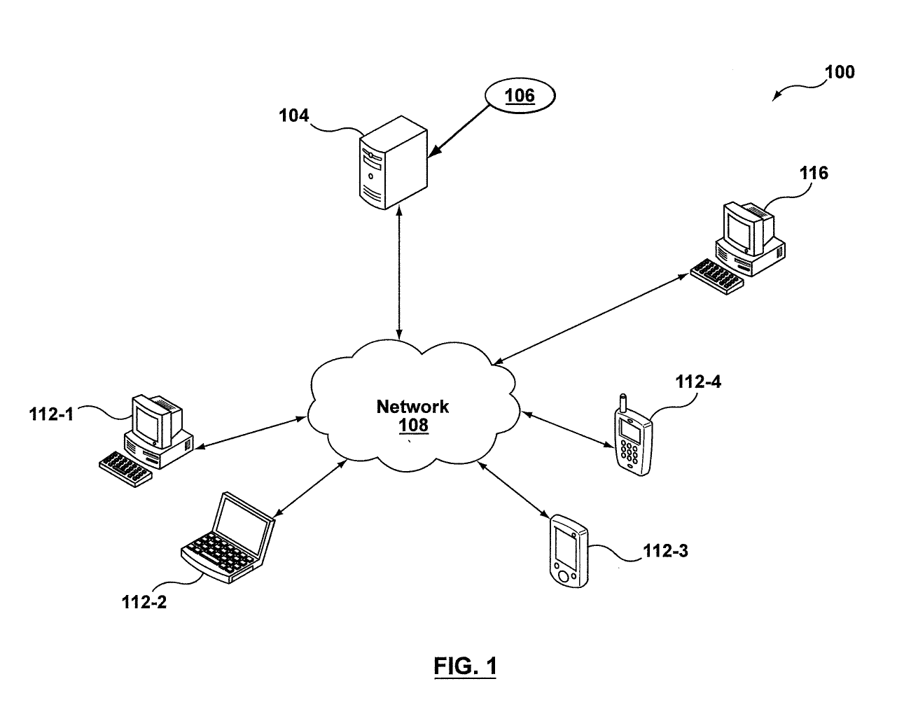

FIG. 1 shows a system 100 for managing data representing a job search project. System 100 comprises a server 104, a network 108, at least one client terminal 112-1, 112-2, 112-3, 112-4 and an administrative terminal 116. (Collectively, terminals 112-1, 112-2, 112-3, 112-4 are referred to as client terminals 112, and generically as client terminal 112. This nomenclature is used elsewhere herein.)

In general terms, server 104 can comprise any platform capable of processing, transmitting, receiving, and storing data. In a present embodiment, server 104 is a Web server configured for database management. Server 104 can be based on any desired server-type computing environment including appropriate configurations of one or more central processing units (CPUs) configured to control and interact with non-transitory computer readable media in the form of computer memory. Computer memory can include volatile memory such as Random Access Memory (RAM), and non-volatile memory such as hard disk drives or FLASH drives, or a Redundant Array of Inexpensive Disks (RAID) or cloud-based storage. Server 104 also includes one or more network interfaces, to connect to network 108, client terminal 112 or administrative terminal 116. Server 104 can also be configured to include input devices such as a keyboard or pointing device or output devices such as a monitor or any of or all of them, to permit local interaction. Other types of hardware configurations for server 104 are contemplated. For example, server 104 can also be implemented as part of a cloud-based computing solution, whereby the functionality of server 104 is implemented as one or more virtual machines executing at a single data center or in a mirrored form across a plurality of data centers. The software aspect of the computing environment of server 104 can also include remote access capabilities in lieu of, or in addition to, any local input devices or local output devices. Any desired or suitable operating system can be used in the computing environment of server 104. The computing environment can be accordingly configured with appropriate operating systems and apps to effect the functionality discussed herein. Those of skill in the art will now recognize that server 104 need not necessarily be implemented as a stand-alone device and can be integrated as part of a multi-purpose server or implemented entirely in software. In a present embodiment, server 104 is configured to execute and host a web-based job search app 106 that is accessible by client terminals 112 and administrative terminal 116. The term “app”, is used herein as a short form for the term software application, to distinguish over other usages of the term “application” herein. In variations, job search app 106 can be implemented as a locally executable client application on client terminals 112, thereby obviating the need for server 104, however this is presently less preferred.

Network 108 can comprise any network capable of linking server 104 with client terminals 112 and administrative terminal 116 and can include any suitable combination of wired and/or wireless networks, including but not limited to a Wide Area Network (WAN) such as the Internet, a Local Area Network (LAN), cell phone networks, WiFi networks, WiMax networks and the like.

Client terminals 112 can be based on any suitable computing environment, and the type is not particularly limited so long as each client terminal 112 is capable of receiving data from server 104, displaying data in graphical form and transmitting data to server 104. [Note to draft: we need to ponder if this invention can be applied to audio output only. Seems unlikely but I would like to canvass the question anyway.] In a present embodiment, client terminals 112 are configured to at least execute a web browser that can interact with the web service hosted in association with app 106 by server 104.

Client terminals 112 can be based on any type of client computing environment, such as a desktop computer, a laptop computer, a netbook, a tablet, a smart phone, a PDA, other mobile computing device or any other platform suitable for graphical display that is known in the art. Each client terminal 112 includes at least one processor connected to a non-transitory computer readable storage medium such as a memory. Memory can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In one embodiment, memory includes both a non-volatile memory for persistent storage computer-readable instructions and other data, and a non-volatile memory for short-term storage of such computer-readable instructions and other data during the execution of the computer-readable instructions. Other types of computer readable storage medium external to client terminal 112 are also contemplated, such as secure digital (SD) cards and variants thereof. Other examples of external computer readable storage media include compact discs (CD-ROM, CD-RW) and digital video discs (DVD).

Client terminal 112 can also include one or more input devices connected to at least one processor. Such input devices are configured to receive input and provide data representative of such input to the processor. Input devices can include, for example, a keypad and a pointing device. A pointing device can be implemented as a computer mouse, track ball, track wheel, touchscreen or any suitable combination thereof. In some examples, client terminal 112 can include additional input devices in the form of one or more additional buttons, light sensors, microphones and the like. More generally, any suitable combination of the above-mentioned input devices can be incorporated into client terminal 112.

Client terminal 112 further includes one or more output devices. The output devices of client terminal 112 can include a display. When the pointing device includes a touchscreen, the touchscreen can be integrated with the display. Each client terminal 112 also includes a communications interface connected to the processor. The communications interface allows client terminal 112 to communicate with other computing devices, for example via network 108. The communications interface is therefore selected for compatibility with network 108.

Administrative terminal 116 can be based on a computing environment that is substantially similar to the computing environments described in relation to client terminal 112. Accordingly, in a present embodiment, administrative terminal 116 is also configured to access app 106 via a web browser executing locally on administrative terminal 116. As will be discussed further below, administrative terminal 116 can be used to configure an instance of app 106, such that the configured instance of app 106 can be accessed via one or more client terminals 112. In alternative embodiments, more than one administrative terminal 116 can be used.

It is also to be understood, that app 106 can be implemented in variations of system 100. For example, app 106 can be configured to be purely local client-based app, thereby obviating the need for network 108, server 104 and administrative terminal 116. For overall context, it is contemplated that server 104 can be operated by, or on behalf of, an enterprise such as an educational institution, a job placement agency, an employment services government agency, or the like, in order to provide a hosted, computer-implemented tool for different individuals seeking employment. The tool allows accounts to be set up in order to manage job searching activities respective to each individual seeking employment. Thus, an administrator associated with the enterprise can utilize administrative terminal 116 in order to configure app 106 to suit the particular circumstances of that enterprise. Having so configured app 106, a first individual may then utilize terminal 112-1 in order to create a first individual account on server 104, and that account can be populated with a first plurality of data records, where each data record represents a particular job searching activity respective to that first individual. Likewise, a second individual can utilize terminal 112-2 in order to create a second individual account on server 104, and populate that second account with a plurality of additional data records, where each additional data record represents a particular job searching activity for that second individual. Likewise, terminal 112-3, terminal 112-4 and additional terminals 112 (not shown), can be used for additional individuals conducting their own individual job search activities. In this manner, server 104 and app 106 can be scaled so that a single enterprise can offer computer-implemented job search project management to a large number of individuals who are seeking employment. It is also contemplated that server 104 can be configured to host app 106, or different instances of app 106, on behalf of a plurality of different enterprises, such that each enterprise can offer its own instance of app 106 to its own set of individuals.

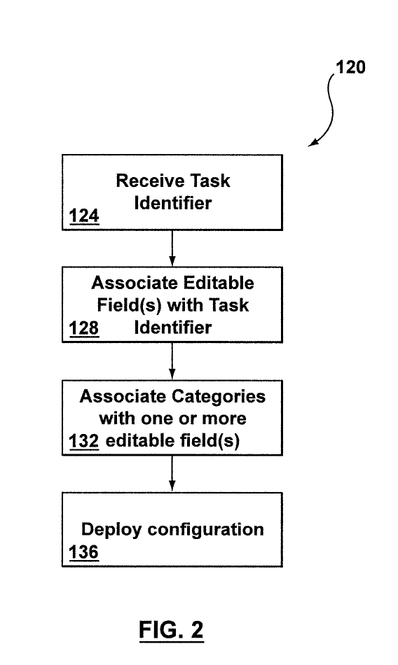

Accordingly, FIG. 2 shows a flow chart illustrating a computer-implemented method 120 for configuring a job search project app. Method 120 is one way in which job search app 106 can be configured using administrative terminal 116 via network 108. Upon completion of method 120, method 140, discussed further below, can be performed via client terminals 112 and used to manage individual job search projects using job search app 106. Also, as will be discussed further below, each job search project can comprise a plurality of records, and each record can be populated according to the configuration established using method 120.

It is to be emphasized that method 120, and various other methods discussed herein, need not be performed in the exact sequence as shown; and likewise various blocks can be performed in parallel or in series; hence the elements of method 120 are referred to herein as “blocks” rather than “steps.” It is also to be understood, however, that method 120 can be implemented on variations of system 100.

Block 124 comprises receiving a task identifier. In one embodiment, in relation to system 100, the task identifier is received by server 104 from administrative terminal 116 via network 108. Generally, a task identifier corresponds with a task that, when completed, will advance at least a portion of a defined job search project towards completion. Some examples of task identifiers can include: “complete job application,” “attend job interview,” “follow-up with prospective employer,” “attend networking event” and “attend meeting.” Other task identifiers will now occur to those of skill in the art.

The various task identifiers are also amenable to shorter forms that, from time to time, can be more convenient. For example, when displaying a task identifier on a display in a small space it can be convenient to use a short form. Both long and short forms of task identifiers are used herein. For greater clarity, “complete job application” can be shortened to “application,” “attend job interview” can be shortened to “interview,” “follow-up with prospective employer” can be shortened to “follow-up,” etc. Additional means for shortening task identifiers and times appropriate to do so will now occur to a person of skill in the art.

Block 128 comprises associating at least one editable field with the task identifier received at block 124. In a present embodiment, the at least one editable data field comprises a record creation time, a scheduled task completion time, an actual task completion time, an “active” status flag, a “complete” status flag, and one or more links to other data fields, or to other records.

Block 132 comprises associating different categories with the states of one or more of the editable fields discussed in relation to block 128. In a present embodiment, three categories are contemplated. The first category corresponds with past tasks, the second category corresponds with present tasks and the third category corresponds with future tasks.

In a present embodiment, one of the three categories is set based on the contents of the active status flag and the complete status flag. Thus, each category is automatically selected according to the following criteria:
A) the first category is selected if the “active” status flag is set to “false” and the “complete” status flag is set to “true,”
B) the second category is selected if the “active” status flag is set to “true”
C) the third category is selected if the “active” status flag is set to “false” and the “complete” status flag is set to “false.”

Block 136 comprises deploying the particular instance of app 106, as configured according to block 124, block 128, and block 132, for access via one or more client terminals 112.

Having configured app 106 using method 120, app 106 can now be accessed from different client terminals 112 in order to manage job search projects.

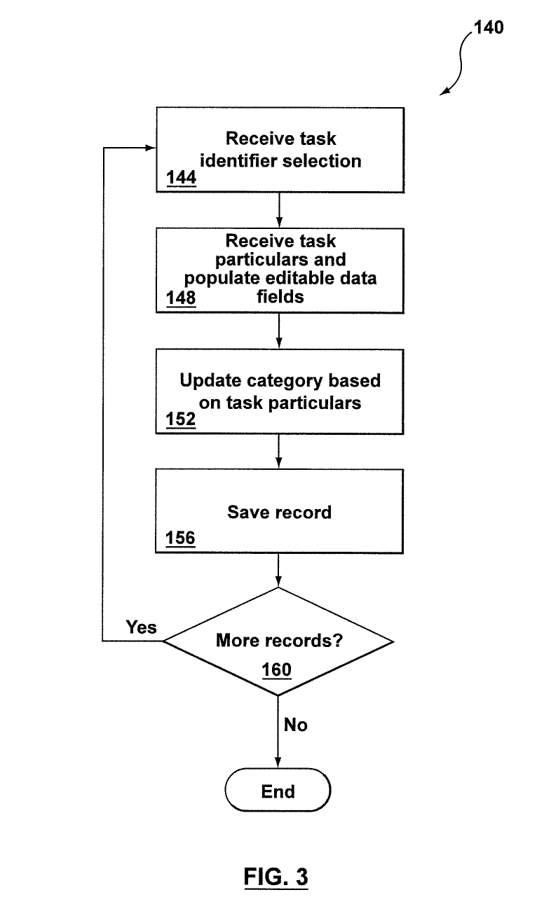

FIG. 3 shows a flow chart illustrating a computer-implemented method 140 for creating a job search project. Method 140 reflects performance of app 106 once app 106 has been configured according to method 120 or otherwise. More particularly, method 140 is one way in which a master data set can be created for subsequent utilization in method 212, discussed further below.

Block 144 comprises receiving a task identifier selection. The selected task identifier can correspond to one of the task identifiers that was defined at block 124 of method 120. Recall various example task identifiers: “complete job application,” “attend job interview,” “follow-up with prospective employer,” “attend networking event” and “attend meeting.”

Block 148 comprises receiving particulars corresponding to the task identifier selected at block 144, and populating the editable data fields with the corresponding task particulars.

Block 152 comprises updating the category setting based on task particulars received at block 148.

Block 156 comprises saving a data record that contains the task identifier selected at block 144, and the various particulars received at block 148.

Block 160 comprises determining if there are more records to be received, such that a yes determination returns method 140 to block 144, and no determination ends method 140.

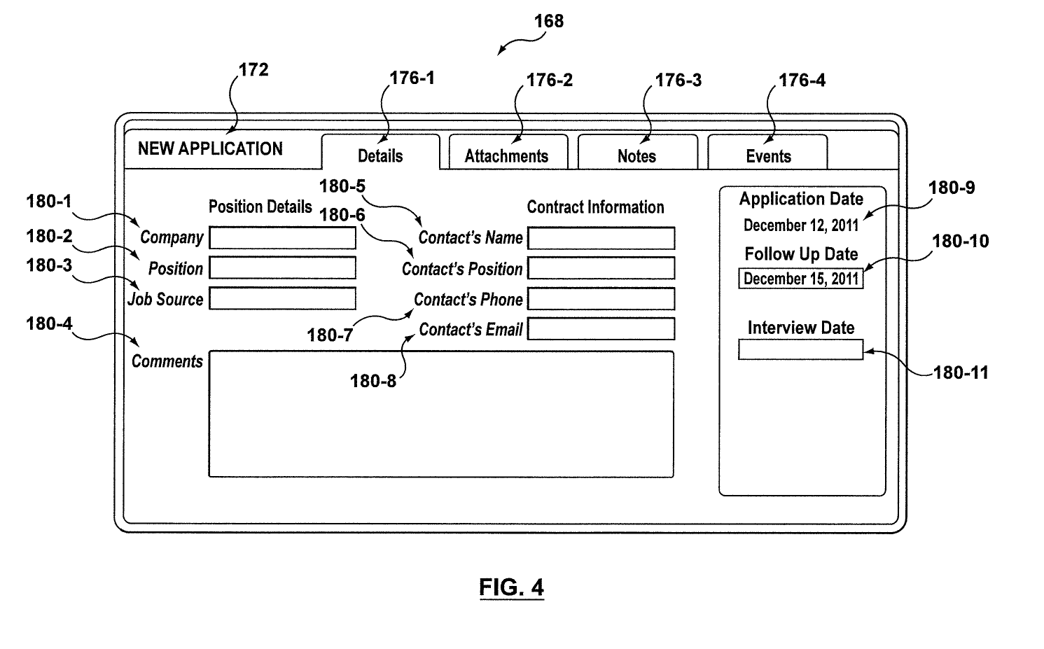

To provide further understanding of method 120 and method 140, FIG. 4 shows a non-limiting example of a graphical interface 168 that can be generated by app 106 on the display of a client terminal 112. Graphical interface 168 comprises a plurality of regions which are generated on the display. Graphical interface 168, in particular, comprises a task identifier field 172. The task identifier field 172, in the example shown in FIG. 4, contains the text “new application”. The text within task identifier field 172 corresponds to one of the task identifiers received at block 124 of method 120. Graphical interface 168 also comprises a plurality of tabs 176, which can be selected in order to bring different editable fields 180 into the foreground for populating and editing by an input device on client terminal 112. Editable fields 180 corresponds to the editable fields defined at block 128.

More specifically, field 180-1 labeled “company” can be populated with the identification of a particular enterprise to which a job application is to be submitted. Field 180-2 labeled “position” can be populated with the identification of a job position that is available within the particular enterprise identified in field 180-1. Field 180-3 labeled “job source” can be populated with the identification of a newspaper publication, a website or any other data that reflects where the information about the availability of the position became known. Field 180-4 labeled “comments” can be populated with notes or any other data pertinent to the application and for which no other data field is available. Field 180-5 labeled “contact name” can be populated with the name of an individual at the company to whom a particular job application is being submitted or is otherwise handling the job application process for that company. Field 180-6, field 180-7, field 180-8 can likewise be populated with further information about the individual identified in field 180-5. Field 180-9, labeled “Application Date” can be populated with the date an application is submitted to the particular enterprise. Field 180-9, can be populated automatically by server 104 using the current date, as shown, or an opportunity to enter the date manually can be provided. Field 180-10, labeled “Follow-Up Date” can be populated with the date that a follow-up activity is to be undertaken. Server 104 can automatically suggest a value for field 180-10, as shown, to be a predetermined time after the “Application Date” based on how the end-user configures the default job application follow-up timeline, or app 106 can be configured to accept a manually entered date. Field 180-11, labeled “Interview Date” can be populated with the date of an interview regarding a position with the particular enterprise. Server 104 can automatically suggest a value for field 180-12 (this field is not shown in the image, but is the interview follow-up date), as shown, to be a predetermined time after the “Interview Date” based on how the end-user configures the default interview follow-up timeline Other editable fields, not shown, can be associated with tab 176-2, tab 176-3 and tab 176-4. For example, tab 176-2 labeled “attachments” can be used to upload or store job posting information, resumes, cover letters and the like that may be used in the application process. Tab 176-3 labeled “Notes” can be populated with additional specific information relating to the job application process. Tab 176-4 labeled “Events” can be populated with calendar entries identifying times and dates of job applications submitted, interviews conducted, follow-up calls made and the like. It is to be reiterated that the specific editable fields shown in FIG. 4 are non-limiting examples. However, such fields are representative of the kinds of fields that can be defined at block 128 of method 120 and populated according to method 140.

Having populated the various fields shown in graphical interface 168, block 152 comprises updating the category setting based on the task particulars received. Recall that in a present embodiment, one of the three categories is set based on the contents of the “active” status flag and the “complete” status flag. Each category is automatically selected according to the following criteria:
A) the first category is selected if the “active” status flag is set to “false” and the “complete” status flag is set to “true,”
B) the second category is selected if the “active” status flag is set to “true”
C) the third category is selected if the “active” status flag is set to “false” and the “complete” status flag is set to “false.”

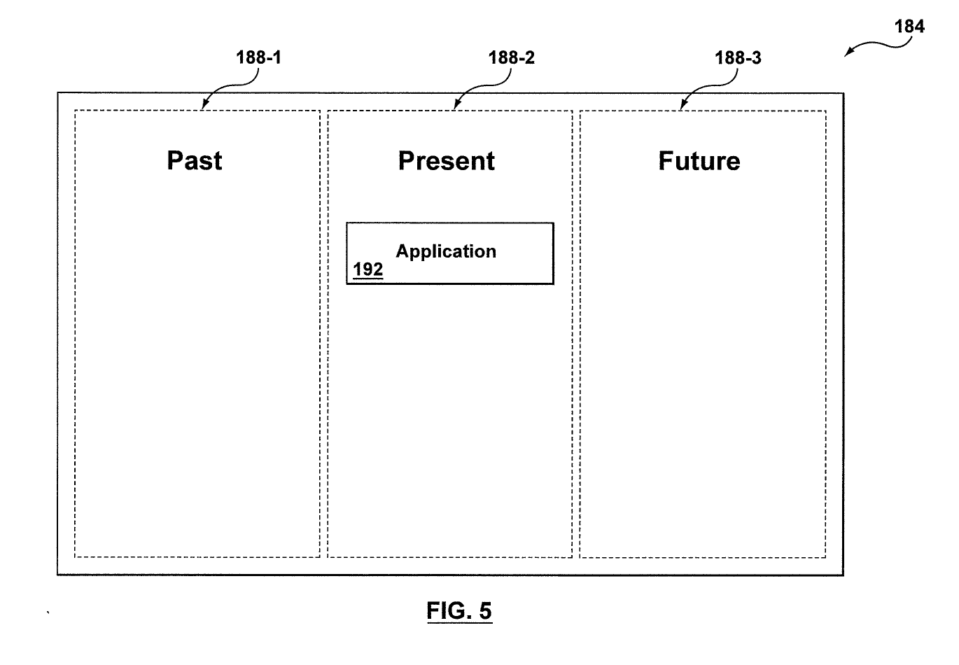

FIG. 5 shows a non-limiting example of a graphical interface 184 that can be generated by app 106 on the display of a client terminal 112. Graphical interface 184 comprises a plurality of regions, 188-1, 188-2 and 188-3, which are generated on the display. In a present embodiment, regions 188-1, 188-2 and 188-3, correspond to the first, second and third categories respectively. Regions 188 can be labeled, as shown, Past, Present and Future respectively. Regions 188 can also be displayed using a different colour for each region. A data object 192, representing a record created by method 120 or method 140, can be displayed by graphical interface 184 according to the category to which it belongs. For example, when a record belongs in the second category, graphical interface 184 can display associated data object 192 in the second region 188-2, as shown. If another category is determined then graphical interface 184 can display the data object 192 in a different region. A data object can be labeled according to the task identifier of its associated record, as shown, where data object 192 is labeled “Application.”

For greater clarity, a data object 192, in a present embodiment, represents a record, including all the data fields that comprise the record. When displayed, however, the data object can show all the data contained in the record, a portion of the data contained in the record or a simple representative label. FIG. 5 illustrates the data object 192 as displaying a representative label, in this case, a shortened form of the task identifier.

The person skilled in the art will now recognize that method 140 can be used to create a plurality of records, all representative of a job search project, which accumulate to form a master dataset. The person skilled in the art will also now recognize that such a master dataset can be edited and supplemented from time to time using client terminal 112.

Making changes to the editable field portion or the category portion of a record is also contemplated. Such a change can be initiated in response to input from client terminal 104 or can be initiated automatically by server 104 in response to a triggering event.

For example, a “complete” status flag can be set to “false” when a record is created but changed to “true” at a later time, in response to input from client terminal 112, to represent the completion of the task associated with that record.

Further, as a result of a change in a data field within a record, a change in the category to which a record is assigned can occur. For example, with respect to system 100, if sever 104 receives instructions to change a “complete” status flag from “false” to “true” in a particular record, then server 104 can also change that record's category from the second category to the first category.

The foregoing description contemplates implementation of method 140 in a passive fashion whereby server 104 generates graphical interface 168 on client terminal 112 as shown in FIG. 4, whereby input can be received at client terminal 112 to populate various fields 176 generated on the graphical interface 168 in order to create a record for use in a master dataset, the record comprising the received task identifier as well as the associated editable field and category. However, a variation of method 140 contemplates an active fashion whereby server 104 automatically creates or modifies various data records in response to what is referred to herein as a triggering event.

Triggering events leading to such automatic creation or modification can be based on any one of a number of possible events. For example, triggering events can include: initiation of a new job search project and changing the contents of an editable field in a record, a particular time or date, reception of a task identifier at server 104 and determination that a follow-up event can be scheduled.

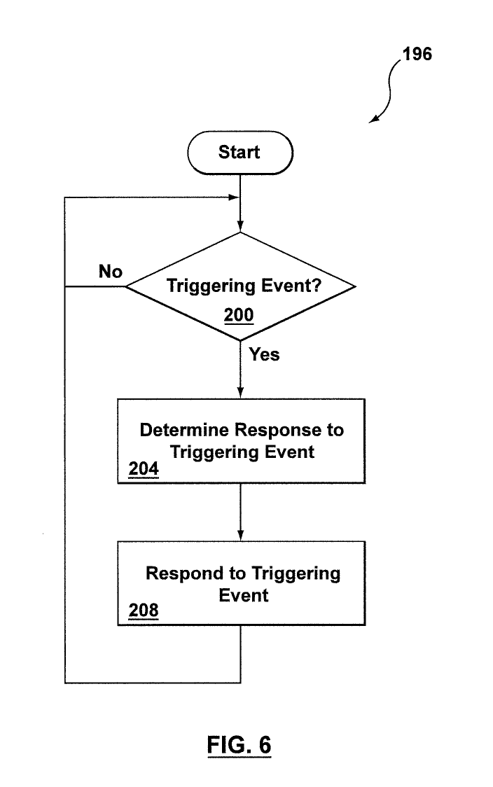

FIG. 6 shows a flow chart illustrating a computer-implemented method 196 for configuring a job search project app. Method 196 is one way in which job search app 106 can be configured using administrative terminal 116 via network 108. Specifically, method 196 is an exemplary method for app 106 to implement triggering events, as discussed above.

At block 200, app 106 determines whether a triggering event has taken place. If no triggering event has taken place the method loops back to the beginning. If a triggering event is detected, the method proceeds to block 204. In a present embodiment, the determination of whether a triggering event has taken place can be done by comparing the event that has occurred with a list of triggering events stored in memory. In some embodiments the list of triggering events can be obtained as input from administrative terminal 116 and client terminal 112, either individually or in combination.

At block 204, app 106 determines a response to the triggering event. In a present embodiment, app 106 can determine the response to a triggering event by comparing the triggering event to a list of responses to triggering events stored in memory.

At block 208, app 106 responds to the triggering event by performing the appropriate response, as determined at block 204.

Not all responses are appropriate for all triggering events. Table 1 shows some examples of triggering events and possible responses.

TABLE 1

| Triggering Event (Block 204) | Possible Responses (Block 208) | |
|---|---|---|
| initiation of a new job | 1. | displaying prompt for input into a |
| search project | | data field |
| | 2. | creating a new record |
| changing the contents of an | 1. | displaying prompt for input into a |
| editable field in a record | | data field |
| | 2. | creating a new record |
| | 3. | automatically populating a data |
| | | field in a record |
| | 4. | changing the category of a record |
| determination that a | 1. | creating a new record |
| particular time or date | 2. | automatically populating a data |
| has been reached | | field in a record |
| | 3. | changing the category of a record |
| reception of a task | 1. | displaying prompt for input into a |
| identifier at server 104 | | data field |
| | 2. | creating a new record |
| | 3. | automatically populating a data |
| | | field in a record |
| determination that a | 1. | displaying prompt for input into a |
| follow-up event can be | | data field |
| scheduled | 2. | creating a new record |
| | 3. | automatically populating a data |
| | | field in a record |

Either through direct input or through automatic triggered events, a record can be associated with more than one other record. For example, a record representing the task “complete job application” can eventually come to be associated with records representing a “follow-up” task and, if successful, an “interview” task. A link editable data field can be used to record each such association.

Below are several additional, illustrative, but non-limiting examples of how method 140 can be implemented, using both passive and active implementations.

A first example can include the generation of the task identifier “application,” drawn from a list of predetermined task identifiers internal to server 104, and the creation of a corresponding record, including an association with a second category and the automatic population of an editable field with a “completion date,” in response to the initiation of a job search project.

A second example can include the changing of a “complete” status flag from “false” to “true” for a record with an “application” task identifier. In this case, server 104 can automatically create a record with a “follow-up” identifier associated with category 3 and a “scheduled completion time” editable field.

A third example can include the reception of the task identifier “interview” at server 104 as a triggering event for the creation of a new record. A record can be created with the task identifier “interview.” The record can be automatically associated with a third category and include editable fields comprising a link to an associated record with the task identifier “application” as well as a “scheduled completion time.”

A fourth example can include a triggering event of the current date being equal to the “scheduled completion time” of a record with a task identifier of “interview.” This triggering event can prompt the creation of a record with a task identifier of “follow-up” that is associated with a third category. The new record can include the editable field of “scheduled completion time.”

A fifth example can include the reception of an instruction to change a “complete” status flag on a record containing an “interview” task identifier from “false” to “true.” In this case, a new record with the “follow-up” task identifier, an associated third category and an editable field of “scheduled completion time” can be created automatically by server 104.

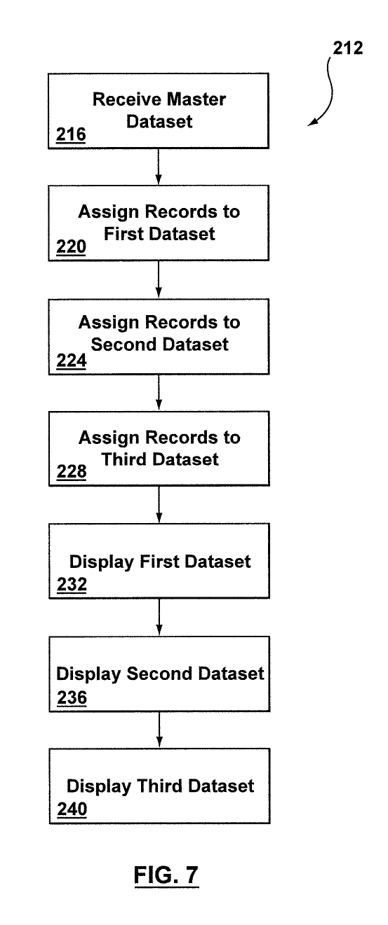

FIG. 7 shows a flow chart illustrating a computer-implemented method 212 for managing data representing a job search project. Method 212 is one way in which server 104 can be configured. It is to be emphasized, however, that method 212 need not be performed in the exact sequence as shown; and likewise various blocks can be performed in parallel or in series; hence the elements of method 212 are referred to herein as “blocks” rather than “steps.” It is also to be understood, however, that method 212 can be implemented on variations of system 100 as well. Method 212 can also be incorporated directly into app 106.

Block 216 comprises receiving a master dataset. The master dataset comprises a plurality of records created in the manner discussed above, each of which belongs to a category and includes a task identifier and at least one editable field, as discussed above. Broadly speaking, the master dataset comprises all the data presently available with respect to a job search project wherein each individual record represents a task directed towards completion of the job search project and data related to the task. In a present embodiment in relation to system 100, the master dataset is received by server 104 from one of client terminals 112 via network 108 in multiple small transmissions spread over time.

Block 220 comprises assigning a portion of the records received in the master dataset to a first dataset according to the category to which each record belongs.

Similarly, block 224 comprises assigning a portion of the records received in the master dataset to a second dataset according to the category to which each record belongs and Block 228 comprises assigning a portion of the records received in the master dataset to a third dataset according to the category to which each record belongs.

In a present embodiment, records from the master dataset are assigned to the first dataset, second dataset and third dataset such that the first dataset comprises records associated with past tasks, the second dataset comprises records associated with present tasks and the third dataset comprises records associated with future tasks.

Block 232 comprises displaying the records assigned to the first data set. Blocks 236 and 240 likewise comprise displaying the records assigned to the second dataset and the third dataset, respectively. In a present embodiment in relation to system 100, server 104 generates commands that will cause client terminal 112 to drive a display to show records in the first dataset in a first region of the display, records from the second dataset in a second region of the display and records from the third dataset in a third region of the display. In a present embodiment, the first region fo the display, the second region of the display and the third region of the display are shown in different colours.

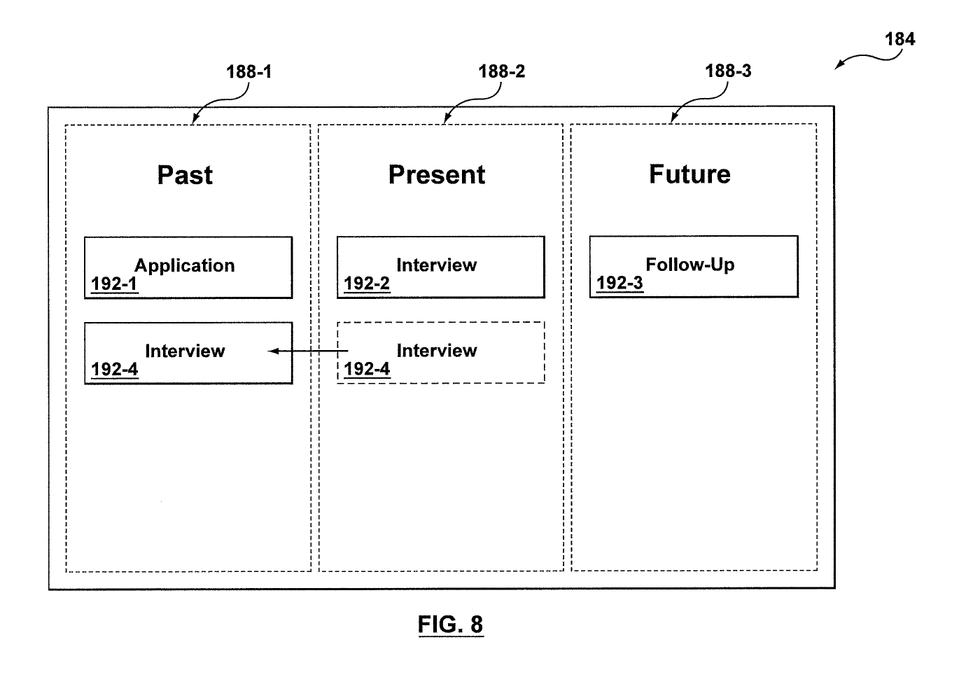

To provide further understanding of method 212, FIG. 8 shows a non-limiting example of graphical interface 184, as discussed above with respect to FIG. 5, that can be generated by app 106 on the display of a client terminal 112. Data objects 192, representing records, can be displayed by graphical interface 184 in one of regions 188 according to the proper category. Multiple data objects 192, each representing a record, can be displayed in multiple regions simultaneously.

When a change in category of a record is registered, then the associated data object 192 can be displayed in the region 188 corresponding to the new category instead of the old category. For example, as shown in FIG. 8, when the “complete” status flag for a record is changed to “true” then the associated data object 192-4 is moved from the second region 188-2 (corresponding to the second category), to the first region 188-1 (corresponding to the first category).

In a present embodiment, as noted above, one of the three categories is set based on the contents of the “active” status flag and the “complete” status flag. Each category is automatically selected according to the following criteria:
A) the first category is selected if the “active” status flag is set to “false” and the “complete” status flag is set to “true,”
B) the second category is selected if the “active” status flag is set to “true”
C) the third category is selected if the “active” status flag is set to “false” and the “complete” status flag is set to “false.”

In some embodiments, the use of more than three categories is also contemplated. For example, four categories can be defined by the use of two status flags; “active” and “complete.” In a four category embodiment each setting for the two flags can be used to distinguish a different category. In this case,
A) the first category is selected if the “active” status flag is set to “false” and the “complete” status flag is set to “true,”
B) the second category is selected if the “active” status flag is set to “true” and the “complete” status is set to “true,”
C) the third category is selected if the “active” status flag is set to “true” and the “complete” status flag is set to “false,”
D) the fourth category is selected if the “active” status flag is set to “false” and the “complete” status flag is set to “false.”

However, in another embodiment, assigning records can be accomplished by determining a current date and assigning records to a first dataset if the scheduled task completion time is earlier than the current date, assigning records to a second dataset if the scheduled task completion time is equal to the current date and assigning records to a third dataset if the scheduled task completion time is later than the current date.

It is also contemplated that, in some embodiments, more than three categories can be defined using times relative to the current date. For example, five categories can be defined to correspond to dates more than 30 days less than the current date, dates between 1 and 30 days less than the current date, dates equal to the current date, dates between 1 and 30 days greater than the current date and dates more than 30 days greater than the current date.

In still other embodiments, combinations of status flag and time based definitions of categories can be used. For example, an initial three categories can be defined using status flags and further divided using times.

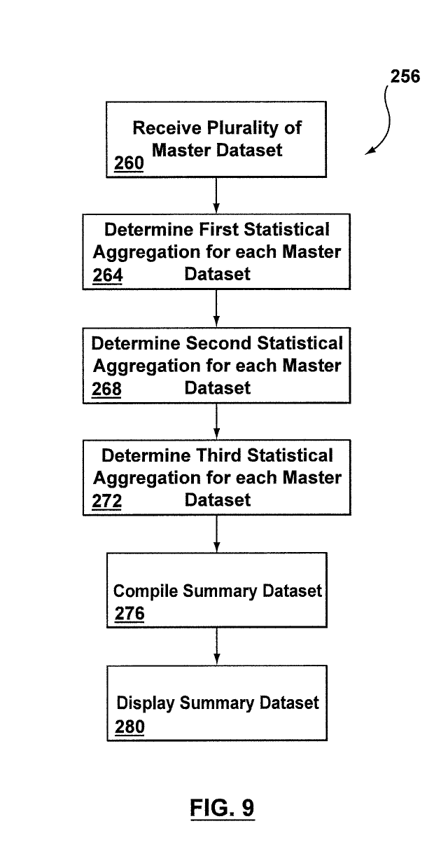

FIG. 9 shows a flow chart illustrating a computer-implemented method 256 for reporting data representing a plurality of job search projects. Method 256 is one way in which server 104 can be configured. It is to be emphasized, however, that method 256 need not be performed in the exact sequence as shown; and likewise various blocks can be performed in parallel or in series; hence the elements of method 256 are referred to herein as “blocks” rather than “steps.” It is also to be understood, however, that method 256 can be implemented on variations of system 100 as well.

Block 260 comprises receiving a plurality of master datasets. The master datasets contemplated are described above in association with method 120 and include the possibility of several additional data fields as well as the category and the task identifier, as previously discussed.

Block 264 comprises assigning a portion of the records of each master dataset to a first statistical aggregation of records for each respective master dataset received according to a category to which each record belongs. In one embodiment, in relation to system 100, the assignment is performed by server 104. However, the assignment can be performed by client terminal 112, administrative terminal 116 or in a distributed manner across any combination of server 104, client terminal 112 and administrative terminal 116 via network 108.

Similarly, block 268 comprises assigning a portion of the records of each master dataset to a second statistical aggregation of records for each respective master dataset received according to a category to which each record belongs and Block 272 comprises assigning a portion of the records of each master dataset to a first statistical aggregation of records for each respective master dataset received according to a category to which each record belongs.

In a preferred embodiment, records from each master dataset are assigned to the first statistical aggregation, second statistical aggregation and third statistical aggregation such that the first statistical aggregation comprises records associated with past tasks, the second statistical aggregation comprises records associated with present tasks and the third statistical aggregation comprises records associated with future tasks. In a present implementation of a present embodiment, assigning records is accomplished by assigning records to a first dataset according to “active” and “complete” status flags, as discussed above.

In another embodiment, assigning records is accomplished by determining a current date and assigning records to a first dataset if the scheduled task completion time is earlier than the current date, assigning records to a second dataset if the scheduled task completion time is equal to the current date and assigning records to a third dataset if the scheduled task completion time is later than the current date.

Block 276 comprises compiling the first, second and third statistical aggregations from each master dataset into a summary dataset. There are many ways in which statistical data can be compiled that will now occur to a person of skill in the art, some of which are discussed below by way of example.

Block 280 comprises displaying the summary dataset. Display of the summary dataset can comprise the display of any portion of the aggregated records and any statistical data. Preferably, the display comprises a predetermined sub-set of the data. For example, the number of records with a task identifier of “application” and the number of records with a task identifier of “interview” from a particular master dataset can be selected for display. For another example, the number of records with a task identifier of “application” and the number of records with a task identifier of “interview” from several master datasets can be shown simultaneously on different portions of the display.

In another embodiment, threshold values associated with each aggregation can be set according to predetermined criteria and those aggregations that exceed the threshold value displayed so as to distinguish them from those that do not exceed the threshold value. More complex statistical operations are also contemplated.

Block 280 can be initiated in response to input from administrative terminal 116, can be updated at fixed intervals or can be initiated automatically by server 104 in response to a triggering event. For example, a triggering event can be a threshold value being exceeded.

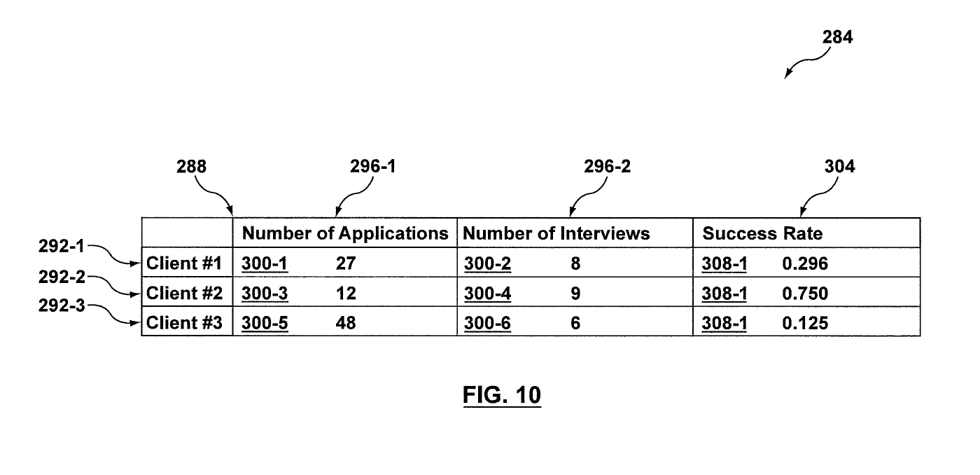

To provide further understanding of method 256, FIG. 10 shows a non-limiting example of an interface 284 that can be generated by app 106 on the display of a client terminal 112. Interface 284 comprises a table 288 that further comprises master dataset identifier fields 292, raw data identifier fields 296, raw data quantity fields 300, calculated data identifier fields 304 and calculated data quantity fields 308.

The master dataset identifier fields 292 contain text that identifies each master dataset for which data is being displayed. In a present embodiment each master dataset represents a job search project for one person.

The raw data identifier fields 296 contain text that identifies which statistical data is being displayed. The text shown in raw data identifier fields 296 can correspond to one of the task identifiers received at block 124 of method 120.

The raw data quantity fields 300 contain quantitative data reflective of the raw data identifier fields 296.

The calculated data identifier field 304 contains text that identifies which statistical measurement is being displayed. In a present embodiment, the text shown is, “success rate,” where success is determined by whether an application results in an interview. The calculated data quantity fields 308 contain quantities reflective of the calculated data identifier field 304. In a present embodiment, the calculated data quantity fields contain the proportion of successful applications.

Several illustrative, but non-limiting examples of compilation and display follow.

For example, compiling can include setting a predetermined threshold for the number of records containing the task identifier “application” in the first category. The display can then be driven to distinguish those aggregations that exceed the threshold amount from those that do not. Distinguishing can be done in any suitable manner, such as grouping those that exceed the threshold in one portion of the display, highlighting those that exceed the threshold using bold text, displaying those that exceed the threshold in a different colour, displaying the region of the display containing those that exceed the threshold in a different colour, ordering according to the amount by which the threshold is exceeded or any other suitable manner known in the art.

For a second example, a predetermined threshold value can be compared with the proportion of records with “application” task identifiers that contain a link to a record with the “interview” task identifier. Those aggregations that exceed the threshold can then be displayed with a green halo on a display while those that do not exceed the threshold can be displayed with a red halo on a display. Another variation can use the proportion of records with a “networking event” task identifier that contain a link to a record with a “meeting” task identifier. Still another variant can use the proportion of records with a “follow-up” task identifier that also contain a “complete” flag set to “true.”

For a third example, a predetermined threshold value can be compared with the number of records with “interview” task identifiers per unit of time since the job search project was initiated.

For a fourth example, the summary dataset can include the proportion of records with “application” task identifiers that contain a link to a record with the “interview” task identifier for many master datasets which are displayed in order across the display.

In the text below, further examples and embodiments are discussed as an aid to further clarifying the implementation of the invention to a person skilled in the art. None of these examples or embodiments should be regarded as limiting the scope of the claims.

Employers may typically offer outplacement to protect their reputations, maintain the morale of remaining employees, forestall lawsuits, and minimize unemployment-insurance payments. While outplacement provides numerous benefits to employer and employee, the process is prohibitively expensive for a large percentage of the potential market.

The systems described herein can provide functionality that augments or replaces traditional outplacement, and one that has a number of significant benefits. For employers, the system can provide a comprehensive solution at a reduced cost of comparable options. The job search system 500, a variant of system 100, can reduce severance-related costs, termination-related liability, and can enable employers to provide transition support to a broad spectrum of employees regardless of their seniority or salary.

For job seekers, the job search system 500 can actively drive career transition success and speeds time to reemployment by empowering its users with the skills of the most effective job seekers. It can provide the structure and knowledge required for a successful search; drive daily activities to established goals; and manage and automate all the administrative aspects of the career transition process.

More particularly, the job search system 500 can provide third parties with the ability to monitor the job seekers and track their progress. The present disclosure relates to a system 500 for monitoring and reporting on the progress of a job search and/or a career transition. In doing so, the job search system 500 may store job search data so as to help a job seeker to plan, organize, automate and execute a job search.

It will be appreciated that numerous specific details are set forth in order to provide a thorough understanding of the exemplary embodiments described herein.

However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, cellular telephone, smart-phone device and wireless hypermedia device. Program code is applied to input and other data to perform the functions described herein and generate output information. The output information is applied to one or more output devices, which may include hardware devices, communication channels and other output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the systems, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, Internet transmissions or downloadings, magnetic and electronic storage media, digital and analog signals, and the like. The computer useable instructions may also be in various forms, including compiled and non-compiled code.

Moreover, the subject systems may be implemented as one or more software components stored on a computer server that is accessible via a client machine in a client-server architecture. In such case, the system can be considered to be a hosted software offering or a software service employed in a software-as-a-service deployment.

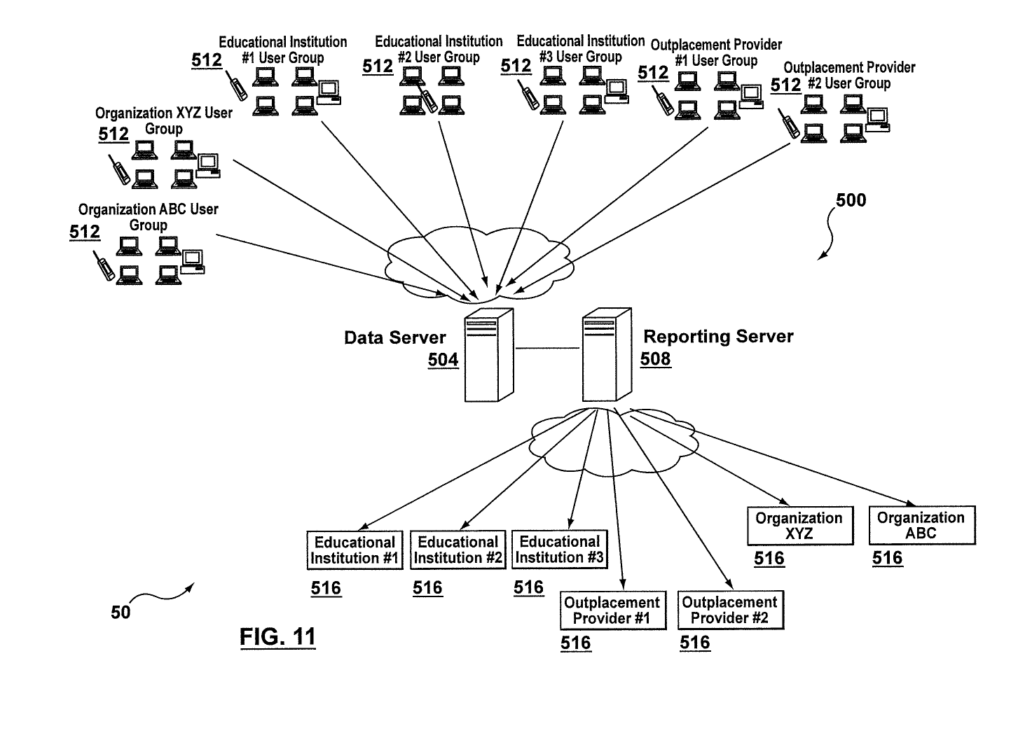

Referring to FIG. 11, therein illustrated is a schematic illustration of a system for facilitating a job search. The job search system 500, a variant of system 100, may include a data server 504 and a reporting server 508.

The data server 504 may include a database for storing job search data and data related to scheduled activities associated with the job search data. Job search data may include user activity details such as the dates, details, descriptions, and contacts associated with all job applications and networking events. Scheduled activities associated with the job search data may include personal meetings, interviews and follow-ups generated from the job application and networking events.

Various job seeker groups 512 (hereinafter referred to as job seeker 512, job seekers 512 and job seeker group 512) may access the job search system 500 through various computing devices, analogous to client terminals 112 (e.g., laptops, smartphones, tablet computers, or desktop computers). Such computing devices may include a display for displaying a user interface. As discussed below, such user interface may have past, present and future sections.

Reporting server 508 may contain a reporting module operably connected to the database. Various third-party groups 516 (hereinafter referred to as third party 516, third parties 516 and third party group 516) may access the reporting module to gain access to reports containing the progress of one or more job seekers 512 using the job search system 500. For example, a career coach may access a report that monitors pending interviews and personal meetings of job seekers 512 for which he/she is coaching so that the career coach can assist with interview and/or meeting preparation. The career coach may also want to monitor the job seeker 512 so that he/she can schedule a post-mortem discussion with the job seeker 512 to debrief on the interview and/or meeting and to provide feedback.

In some embodiments, the reporting module may be configured, for example, in the manner of method 256, to provide statistical data derived from the job search data or the one or more activities associated with the job search data. For example, a statistical data may be a target achievement statistic associated with job application or networking event targets that have been set for a job seeker 512.

Targets, analogous to thresholds discussed with FIGS. 9 and 10 above, may be set for any number of activities associated with a job search. For example, targets may be set for the number of job applications submitted, the number of networking events attended, the number of interviews obtained from the submitted job applications, or the number of personal meetings resulting from the networking events. Targets may also be set for the number of follow-ups after any of the previous activities.

An example of a target achievement statistic may include a metric for determining if the number of applications submitted by a job seeker 512 has met a job application target that has been set. The reporting module may be configured to flag job seekers 512 who have failed to adhere to the targets to the interested third party 516 in a report so the monitoring third party 516 may be able to take the appropriate corrective action. As discussed below, depending on the nature of the third-party 516, the third-party 516 may set targets and respond to the target achievement statistic in different ways. The end-user may further set targets based on personal preference, and/or the recommendations provided within the system or as prescribed by a third-party 516.

In cases where the job search data includes job application data corresponding to a plurality of job applications, and one or more scheduled activities include at least one interview resulting from the plurality of job applications, the target achievement statistic can be a metric comparing the at least one interview against the plurality of job applications. For example, this may include an “interviews received per application submitted percentage” conversion ratio.

In other cases where the job search data includes networking event data corresponding to a plurality of networking events, and one or more scheduled activities include at least one personal meeting resulting from the plurality of networking events, the target achievement statistic can be a metric comparing the at least one personal meeting against the plurality of networking events. For example, this may include a “personal meetings received per networking event percentage” conversion ratio.

The reporting module may further be configured to generate an evaluation and/or a recommendation based on the target achievement statistic. For example, for the “interviews received per application submitted percentage” conversion ratio, the reporting module may be configured to identify job seekers 512 with a low conversion ratio. Such identification may result in an evaluation (e.g., in the form of an evaluation report) indicating that the job seeker 512 produces substandard quality of applications, resumes or cover letters. Or, the evaluation may indicate a poor fit of job seeker 512 to jobs being applied to. The reporting module may also be configured to provide a recommendation (e.g., in the form of a recommendation report) to the job seeker 512 so that they (or the monitoring) third-party group 516) may assist in helping the job seeker 512 to improve their job applications. For example, the recommendation may include resume or cover letter tips.

Similarly, if the target achievement statistic is a “personal meetings received per networking event percentage” conversion ratio, the reporting module may also be configured to identify low conversion ratios. Such identification may result in an evaluation indicating substandard quality of communications, networking skills, phone manner, self marketing, or fit with intended networking targets. The reporting module may also be configured to provide a recommendation so that they (or the interested third party 516 monitoring the job seeker 512) may assist in helping the job seeker 512 to improve their networking skills. For example, the recommendation may include classes on public speaking to ease a job seeker's shyness at networking events.

Depending on the third-party group 516 monitoring the progress of the job seeker 512, the target and the target achievement statistic, or threshold, may be different.

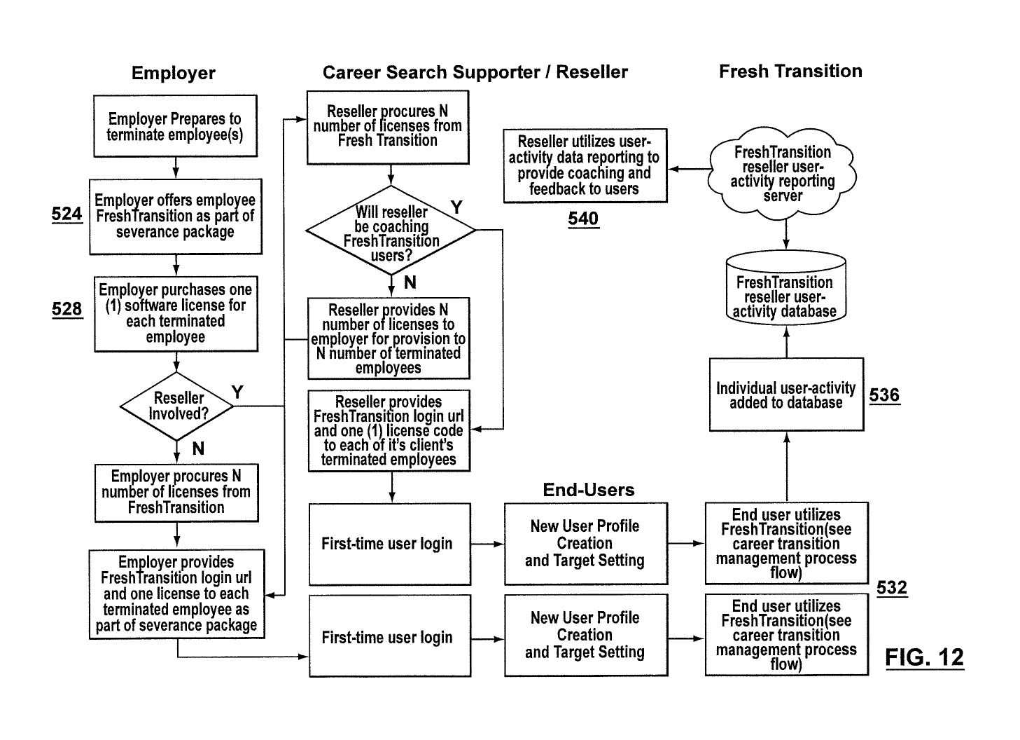

Referring to FIG. 12, shown there is a flowchart diagram 520 illustrating the steps of monitoring the progress of a job search, as may be performed by a career search supporter of the job seeker 512.

A career search supporter may be any individual or entity capable of providing career transition oriented services, and who would be interested in monitoring the progress of a job seeker 512. Examples of a career search supporter may include a career coach, a corporate recruiter, an outplacement provider, a human resource consultant, a corporate recruiter, a temp agency, a consultant, a pension and benefits providers, a payroll processor, and an outsourced service provider.

The career search supporter may provide appropriate metrics as targets for a job seeker 512. Depending on the career search supporter and the purpose in monitoring the progress of the job seeker 512, the target may change.

For example, the monitoring third party 516 may be a career search supporter who is a career coach of a job seeker 512, wherein the career coach may provide guidance and/or support to improve the job seeker's job search skills effectiveness. In such case, the career coach may use the reporting module to monitor the progress of their client job seekers 512, and the job search data can be configured to cater to the relationship between the career coach and the job seeker 512. Particularly, the target can correspond to a prescribed goal provided by a career coach, and the target achievement statistic can correspond to a threshold for determining a job search progress statistic of the job seeker 512. An example of a job search progress statistic may be the percentage change in the conversion ratios discussed above from one three-month period to the next three-month period.

The services of a career search supporter may be provided to a terminated employee by a former employer. This may be the case, for example at step 524, if an employer chooses to provide a terminated or affected employee with access to the job search system 500 as part of a severance package.

In various embodiments, the use of the subject system may be sold to an employer, at step 528, in combination with the services of a career search supporter. For example, the career search supporter may provide a license to the employer who in turn provides the license to the terminated employee. As the job seeker 512 uses the job search system 500, at step 532, his/her activity levels can be recorded in the database at step 536, which is accessible to the career search supporter via the reporting module. The career search supporter may then interpret the generated data and use the findings to provide assistance to the job seeker 512 at step 540. Since the job search system 500 may be provided to job seekers 512 through a career search supporter, the career search supporter can be considered a reseller of the job search system 500.

In further embodiments, the monitoring third party 516 may be a former employer of a job seeker 512. In such scenario, the former employer may provide a post-employment benefit that is contingent upon the terminated employee seeking new employment. The reporting module may then be used by the former employer to ensure adherence to the terms of the post-employment benefits package. That is, the target can correspond to a prescribed goal provided by a former employer, and the target achievement statistic can correspond to a threshold for determining eligibility for a post-employment benefit provided by the former employer.

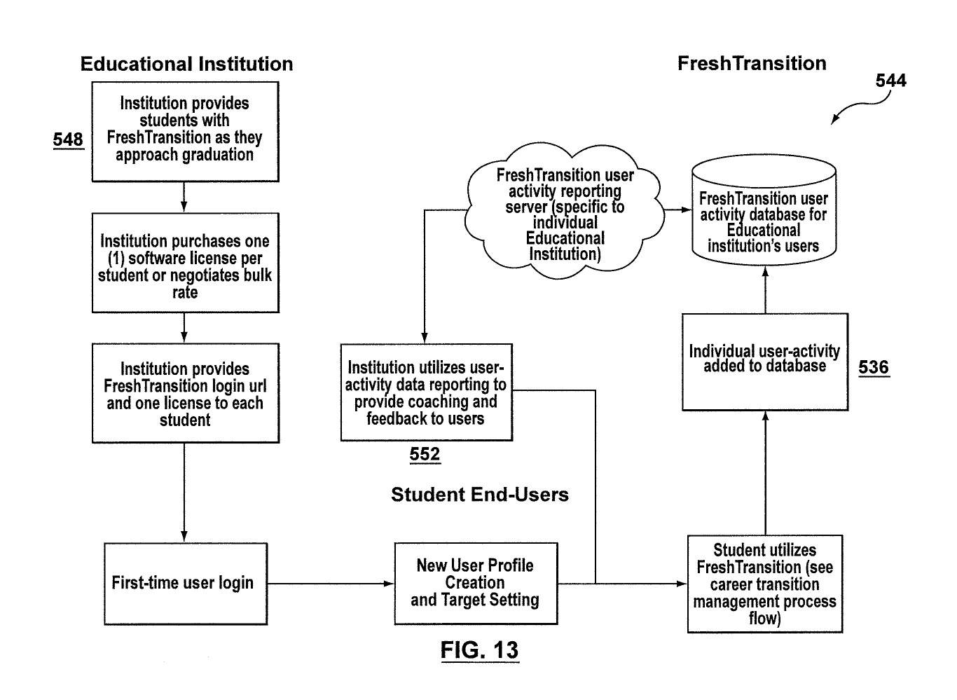

Referring to FIG. 13, shown there is a flowchart diagram 544 illustrating the steps of monitoring the progress of a job search, as may be performed by an educational institution.

In various embodiments, the monitoring third party 516 may be an educational institution. This may be the case, for example, if an educational institution chooses to provide students who are preparing to transition to the workforce with access to the job search system 500 at step 548. Personnel from the educational institution may then use the reporting module to monitor and measure the effectiveness of the students using the system for the purposes of intervening to assess, provide guidance, or support to improve the job seekers' effectiveness at step 552. In some cases, the reporting module may actually be used in the grading of students. In such case, the target can correspond to a prescribed goal provided by an educational institution, and the target achievement statistic can correspond to a threshold for determining grading at the educational institution.

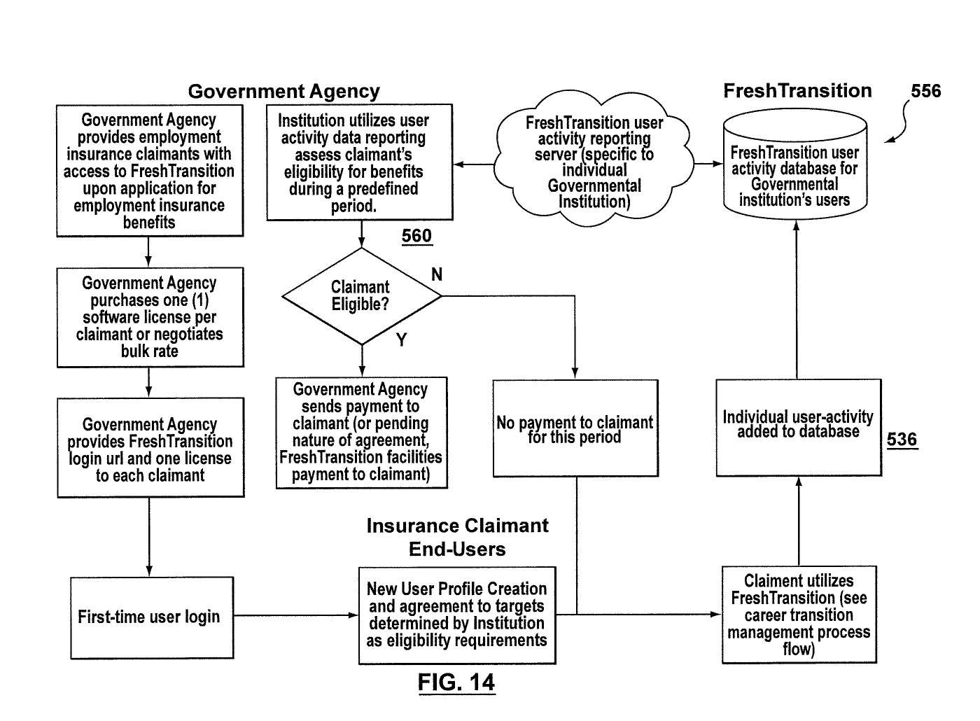

Referring to FIG. 14, shown there is a flowchart diagram 556 illustrating the steps of monitoring the progress of a job search, as may be performed by a government agency. In such case, the third-party group 516 may be a government agency monitoring a job seeker 512 for the purpose of determining eligibility for employment (unemployment) insurance. In such case, the target can correspond to a prescribed requirement of a government agency, and the target achievement statistic can correspond to a threshold for determining eligibility for benefits payments under insurance provided by the government agency. That is, the government agency may determine claimant eligibility based on an adherence to pre-defined or prescribed level of job search activity targets (such as a required number of job applications and/or networking events per day or per week). Those claimants who achieve the predetermined level of activity during a predetermined timeframe may be deemed eligible, while those who do not maintain the required level of activity during the predetermined timeframe may be deemed ineligible.

In some cases, such reports on job seekers 512 generated by the reporting module may be reviewed by government agency staff members to determine claimant eligibility at step 560. In other cases, the reporting module may be integrated with internal systems used by the government agency so as to provide an automated determination of claimant eligibility and benefits payment dissemination.

Individual job seeker records can be kept private and are not shared with any other job seekers 512 of the system. Job seeker activity data from each job seeker 512 within a group can be reported on by the group administrator (i.e., the monitoring personnel associated with a third-party group 516), but the system may be configured to not share this reported data with other job seekers 512 or group administrators. While group administrators may be able to report on their respective user group, the system may provide for a master administrator that may report on any job seeker 512, any user group, a subset of user groups, or all job seeker activity across all user groups.

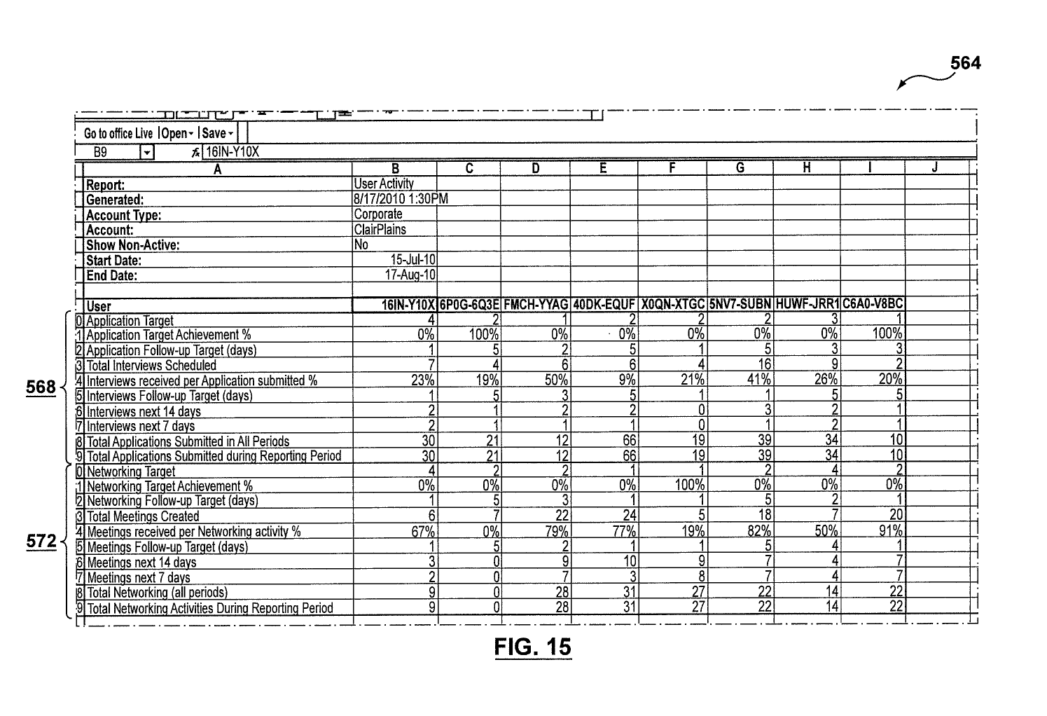

Referring to FIG. 15, illustrated there is an example User Activity Report 564 for a job seeker 512 as may be viewed by a monitoring third party 516. While some of the reporting functionality has already been discussed above, the following provides a non-exhaustive list of data items that may be reported on by the monitoring module with respect to activities recorded in, and/or automatically scheduled by the system for a job seeker 512. Those of skill in the art will recognize that User Activity Report 564 is an alternative version of interface 284 and can also be generated by method 256.

With respect to job application data 568, there may be reports directed at: job application targets, job application target achievement percentage, application follow-up target (days), total interviews scheduled, ratio of interviews received per applications submitted, interview follow-up target (days), upcoming interviews in next 14 days, upcoming interviews next 7 days, total applications submitted in all time periods, and total applications submitted during a given reporting period.

With respect to networking event data 572, there may be reports directed at: networking event targets, networking event target achievement percentage, networking follow-up target (days), total personal meetings scheduled, ratio of personal meetings received per networking events attended/scheduled, personal meeting follow-up target (days), upcoming personal meetings in next 14 days, upcoming personal meetings next 7 days, total networking events in all time periods, and total networking events during a given reporting period.

Discussion will now turn to how data in the database may be entered and generated in the job search system 500 by a job seeker 512.

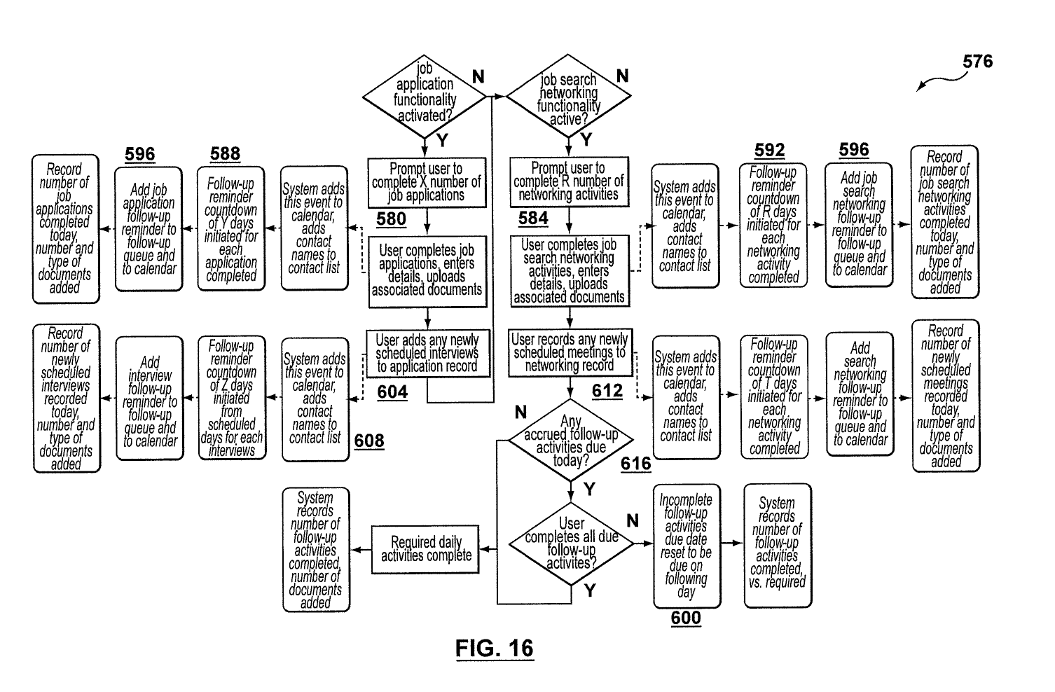

Referring to FIG. 16, shown there is a flowchart diagram 576 illustrating various steps for facilitating a job search as performed by one embodiment of the system described herein.

The job search system 500 can facilitate the setting of daily targets specific to the level of job application activity and/or networking event that a job seeker 512 will commit to undertake. Based on these targets, the system can prompt job seekers 512 to undertake the following activities to which they have committed: daily and/or weekly job application targets at step 580, and daily and/or weekly networking event targets at step 584.

The job search system 500 can also facilitate the setting of targets specific to the follow-up activities that should follow job applications and networking events undertaken by the job seeker 512. Job seekers 512 can set targets that specify the number of days following a job application at 588 and the number of days following a networking event at 592 after which the system will prompt them to follow-up on the particular activity. The following follow-up activities can be automatically scheduled by the system at 596 based on the follow-up targets set by the job seeker 512: job application follow-up timeline targets, job interview follow-up timeline targets, networking follow-up timeline targets, and personal meeting follow-up timeline targets.

Job seekers 512 can override the dates scheduled by the system and can also manually add additional follow-up activities as necessary.

If a follow-up is not completed, the system will continue to prompt the job seeker 512, at steps 580 or 584 to complete the particular follow-up until the job seeker 512 indicates in the system that it has been completed.

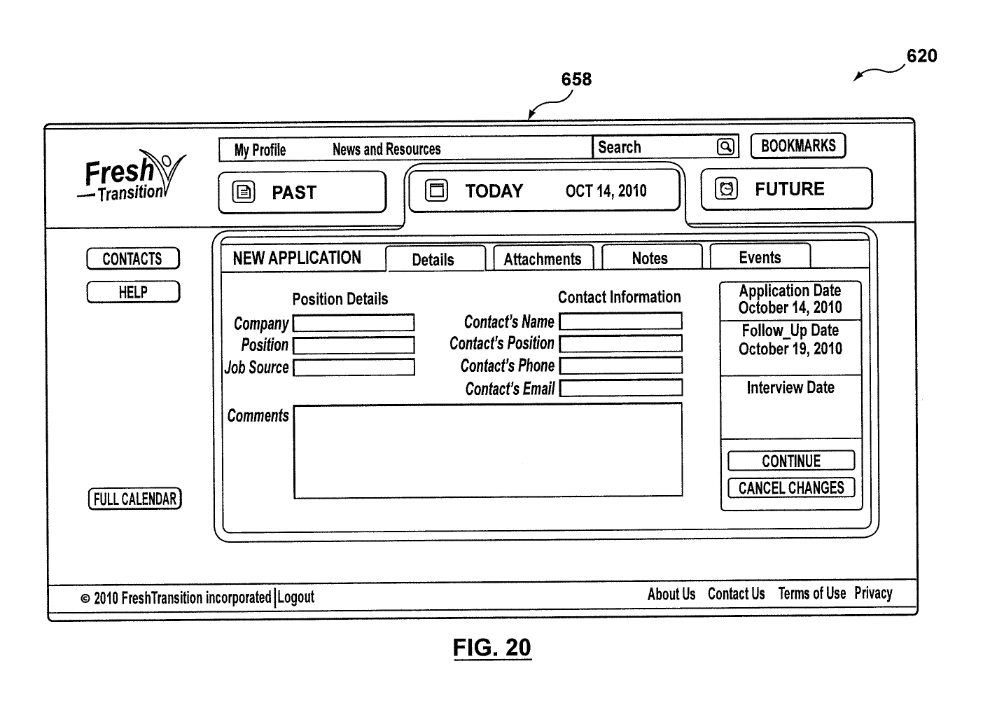

The job seeker 512 records his/her job application activity within the system by recording a New Application event. That is, after having submitted a job application to an employer, recruiter and the like, the job seeker 512 enters the particulars of the job application within a job application record (described below in relation to FIG. 20). Those of skill in the art will recognize that the creation of a job application record can be a particular instance of implementation of methods 120 and 140. Once the details of the job application record are entered and saved in the system by the job seeker 512, the system automatically schedules a job application follow-up date, for example, according to method 196, in the system's calendar that corresponds to the job application follow-up target as specified in the job seeker's established job application follow-up target.

The job seeker 512 can wait until the date the follow-up activity is scheduled for, or he/she can complete the follow-up activity in any of the days prior to the scheduled date. If the follow-up activity is not completed on, or prior to, the scheduled follow-up date, the system can automatically reschedule the follow-up activity to the next business day at step 600, effectively adding it to the list of follow-ups to be completed on that day. Any incomplete follow-ups can continue to be rescheduled until the job seeker 512 takes the action to complete the follow-up and indicates it as completed within the system. At any time, the job seeker 512 can reschedule (change the date of) a follow-up activity, and/or choose to manually add additional follow-up(s) in addition to follow-ups previously scheduled by the system.

If the job seeker 512 is offered an interview in response to the application he/she submitted and recorded in the system, the job seeker 512 can perform the “Add an Interview” step 604 to the previously recorded job application, for example, according to methods 120 and 140. There is no limit to the number of interviews that can be added to a particular job application record. For each interview added, the job seeker 512 can indicate the name of the interviewer, the date, time, location, and any notes associated with the interview. Once the interview is saved in the system, the system automatically schedules an interview follow-up date at step 608, or according to method 196, in the system's calendar that corresponds to the interview follow-up target as specified in the job seeker's established interview follow-up target.

The job seeker 512 can wait until the date the follow-up activity is scheduled on the completed the follow-up activity, or he/she can complete the follow-up activity in any of the days prior to the scheduled date. If the follow-up activity is not completed on, or prior to, the scheduled follow-up date, the system will automatically reschedule the follow-up activity at step 600 to the next business day, effectively adding it to the list of follow-ups to be completed on that day. Any incomplete follow-ups will continue to be rescheduled until the job seeker 512 takes the action to complete the follow-up and indicates it as completed within the system. At any time, the job seeker 512 can reschedule (change the date of) a follow-up activity, and/or choose to manually add additional follow-up(s) in addition to follow-ups previously scheduled by the system. Failing to indicate that a task has been completed on time can be a triggering event for method 196.

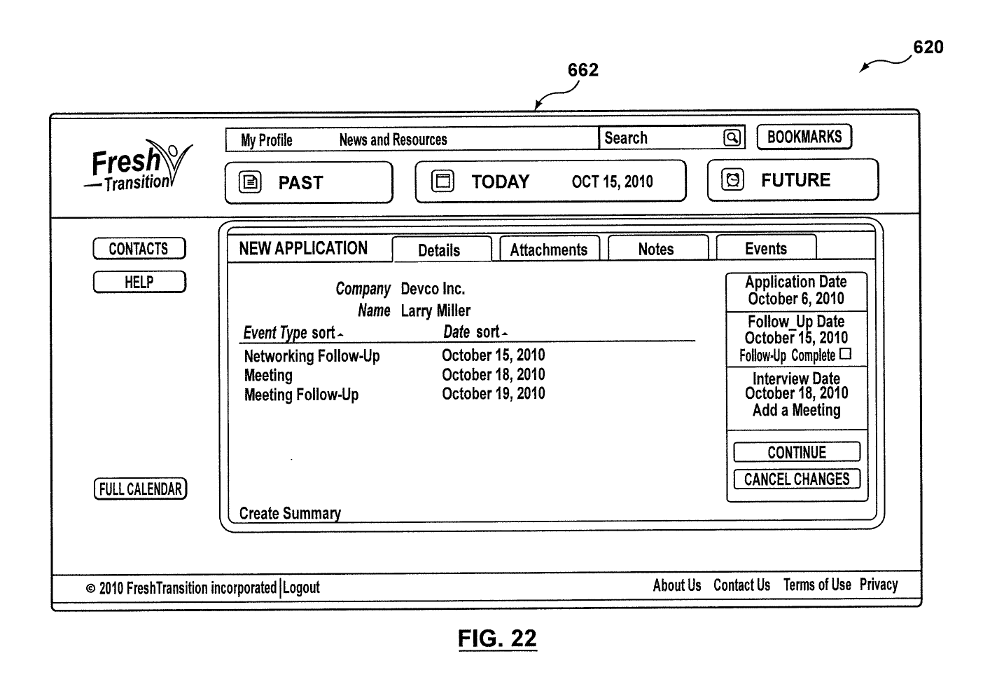

The job seeker 512 records his/her networking activity within the system by recording a New Networking event at 612. After partaking in a networking event, the job seeker 512 enters the particulars of a networking event within a networking event record (as described below in relation to FIG. 22 or according to methods 120 and 140). Once the details of the networking event record are entered and saved in the system by the job seeker 512, the system automatically schedules a networking event follow-up date at 616 in the system's calendar that corresponds to the networking event follow-up target as specified in the job seeker's established networking event follow-up target.

There is no limit to the number of personal meetings that can be added to a particular networking event record. Once the personal meeting is saved in the system, the system automatically schedules a personal meeting follow-up date in the system's calendar that corresponds to the personal meeting follow-up target as specified in the job seeker's established personal meeting follow-up target.

The job seeker 512 can wait until the date the follow-up activity is scheduled on to complete the follow-up activity, or he/she can complete the follow-up activity in any of the days prior to the scheduled date. If the follow-up activity is not completed on, or prior to, the scheduled follow-up date, the system can automatically reschedule the follow-up activity to the next business day at step 600, effectively adding it to the list of follow-ups to be completed on that day. Any incomplete follow-ups will continue to be rescheduled until the job seeker 512 takes the action to complete the follow-up and indicates it as completed within the system. At any time, the job seeker 512 can reschedule (change the date of) a follow-up activity, and/or choose to manually add additional follow-up(s) in addition to follow-ups previously scheduled by the system, for example, according to methods 120 and 140.

The job search system 500 can timestamp all job application records, networking event records and other activities associated with the particular job application or networking event, and can provide a complete audit trail of all activities associated with any such activity, including all dates of networking events, and dates of associated follow-ups, personal meetings, and personal meeting follow-ups.

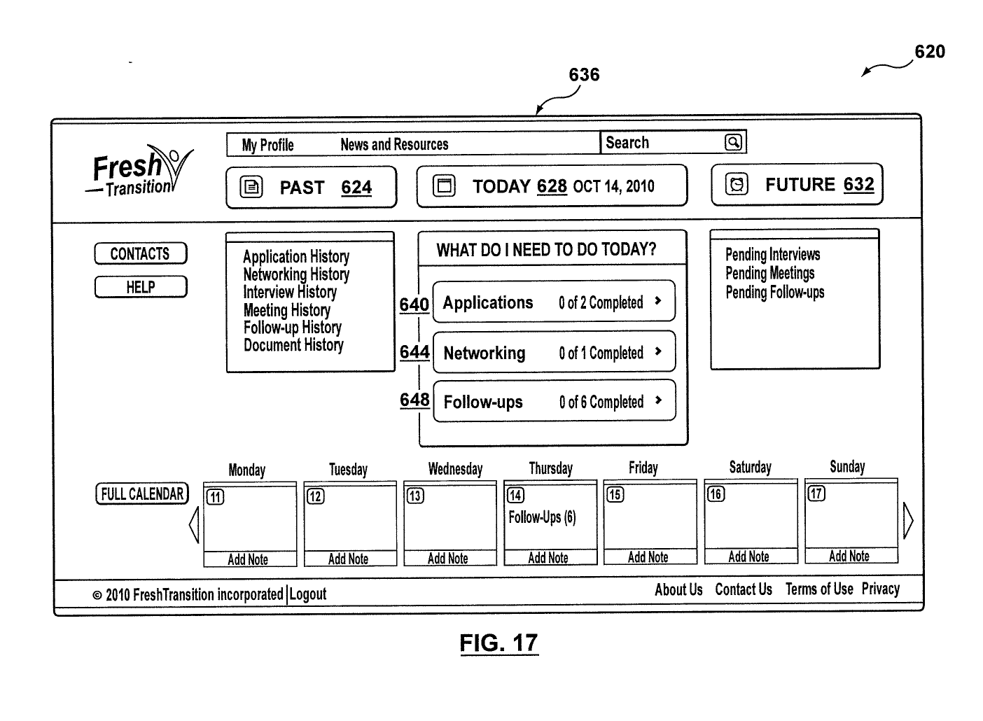

Referring to FIG. 17, shown there is an example user interface 620 of the system described herein, including past, present and future sections 624, 628 and 632 respectively, that will be seen as analogous to regions 188 described above. The job search system 500 can use a simple timeline-based user interface to provide a simple visible representation of the progressive nature of the job search and career transition process. The interface enables job seekers 512 to easily manage the current day's required activities, and quickly find information pertaining to job search and career transition activities previously undertaken and/or job search and career transition activities that will occur in the future. In some embodiments, the different sections of the user interface (past, present and future) may be displayed using different colors on the user interface.

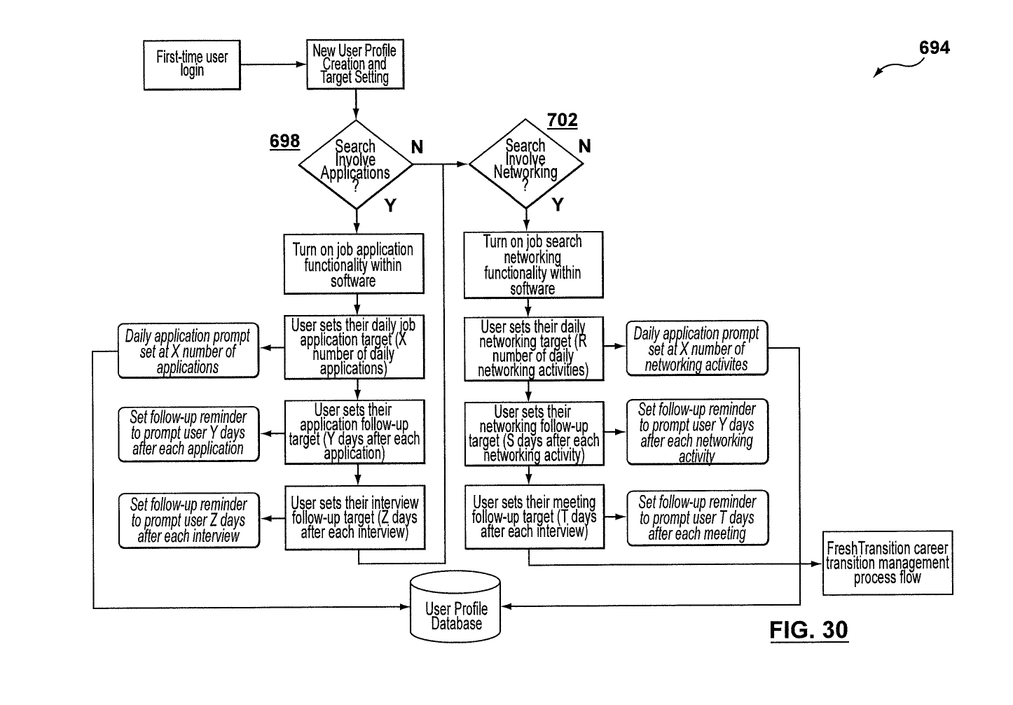

Once enrollment (described below in relation to FIG. 30) is complete the job seeker 512 is taken to the “Home” page 636 of the job search system 500. The “Home” page 636 can provide the job seeker 512 with an overview of all activities requiring completion by the job seeker 512 on the current day. This information can be dynamic and specific to the particular job seeker 512 based on the targets established during the enrollment phase. Information presented to the job seeker 512 includes the number of job applications requiring completion on the current day 640 (as specified in the job seeker's established job application target), the number of networking events requiring completion on the current day 644 (as specified in the job seeker's established networking event target), and the number of follow-up activities requiring completion 648 (based on the follow-ups scheduled automatically by the system based on the job seeker's established follow-up targets).

App 106, system 100 or system 500 can have additional functionality built in. Below are found some non-limiting examples of such additional functionality.

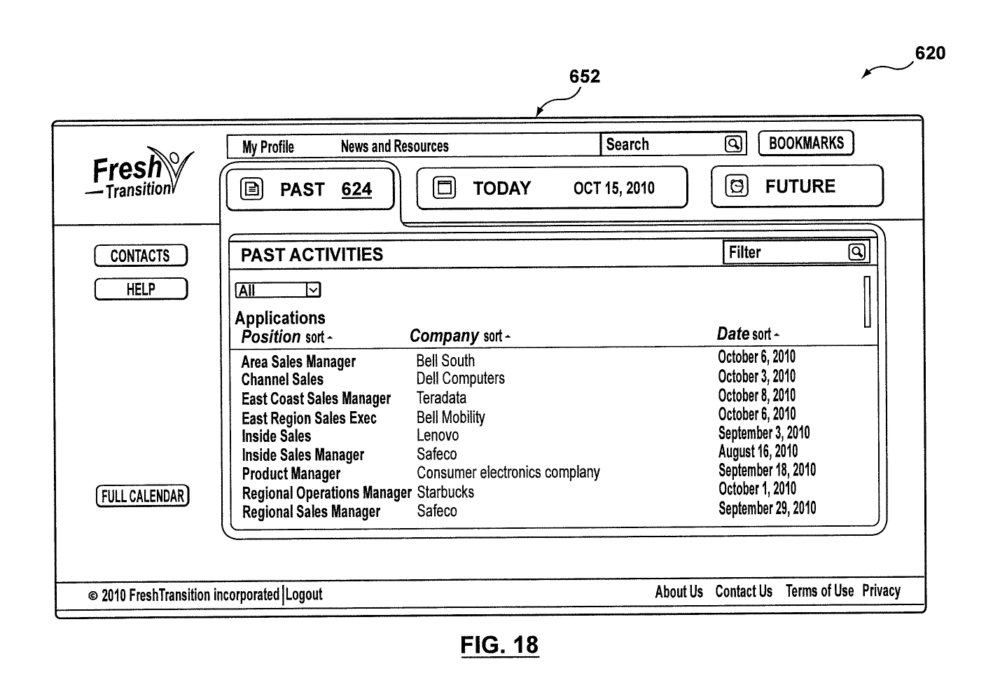

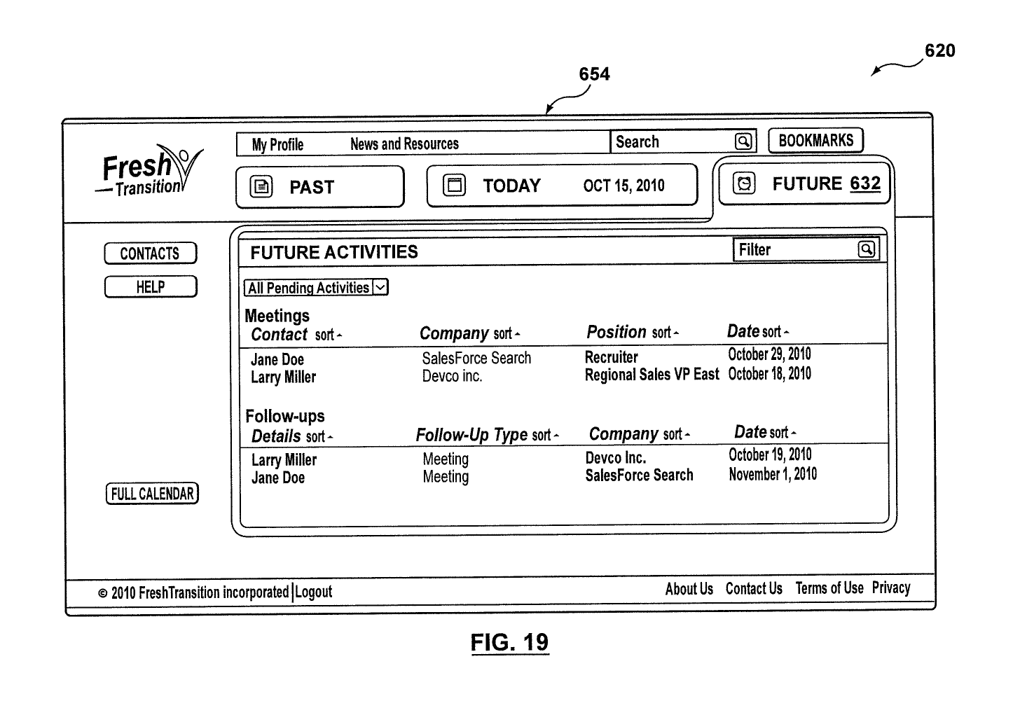

Referring to FIGS. 18-19, shown there are screenshots of an example user interface 620 for a Past Activities Page 652 and a Future Activities Page 654 respectively. Recall that regions 188 of FIG. 5 and FIG. 8 are described above as ways in which regions of a display can be defined according to the present teachings. However, regions 188 can be represented in different ways and remain within the scope of the invention. For example, as shown in FIGS. 17, 18 and 19, regions 188 can be represented as expandable tabs that, when selected, can be shown to overlay other portions of the display, including portions of other, unselected regions 188. When selected, a tab can expand and show a greater amount of detail regarding the records being displayed, as shown by the “past” tab in FIG. 18 and the “future” tab in FIG. 19. When unselected, a tab can contract and show a lesser amount of detail regarding the records being displayed as shown by the “today” and “future” tabs in FIG. 18 and the “today and “past” tabs in FIG. 19.

For greater clarity, FIGS. 17, 18 and 19 show an interface 620 that corresponds with graphical interface 184, as shown in FIGS. 5 and 8. Also, Past, present and future sections 624, 628 and 632 correspond with regions 188-1, 188-2 and 188-3, respectively.

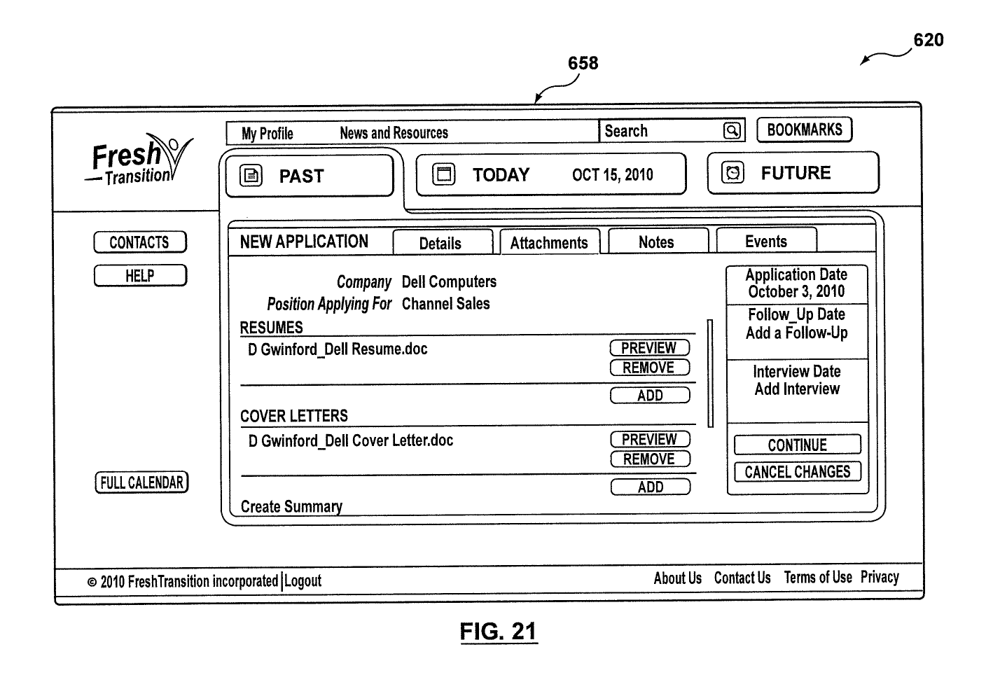

Referring to FIG. 20-21, shown there are screenshots of an example user interface 620 of a Job Application Record Page 658, as may be used to store job application data 568 according to methods 120 and 140, provided by a job seeker 512. The job search system 500 organizes job seekers' job search by storing records of job applications that include:
The particulars of the role including the company name, position applied to/job title, role description, and source of the opportunity
Information pertaining to the contact information of individuals that may be associated with the role or the advertisement of the role; including contact's name, contact's position, contact's phone number, and contact's email
Any documents submitted with the application such as resume and cover letter can be uploaded and attached to a particular job application record
Any documents submitted or correspondence undertaken to follow-up on the application can be uploaded and attached to the particular application record
Any other research or information associated with the application and company applied to can be uploaded and attached to the particular application record
Any notes associated with the initial job application or any subsequent activities
Information pertaining to interviews associated with a particular application, including date(s), time(s), location(s), interviewer(s) name, position(s)/role(s)

Referring to FIG. 22, shown there is an illustration of the events tab of a Networking Event Record Page 662, as may be used to store networking event data 572 provided by a job seeker 512, in an example user interface 620. The job search system 500 organizes job seekers' job search by storing records of networking events, according to methods 120 and 140, that include:
Information pertaining to the contact information of the individual(s) associated with the networking event; including contact's name, employer, contact's position, contact's phone number, and contact's email
Any documents associated with the networking event such as resume and cover letter can be uploaded and attached to the particular networking event record
Any documents submitted or correspondence undertaken to follow-up on the networking event can be uploaded and attached to the particular networking event record
Any other research or information associated with the networking event can be uploaded and attached to the particular networking event record
Any notes associated with the initial networking event or any subsequent activities
Information pertaining to personal meetings associated with a particular networking event, including date(s), time(s), location(s).

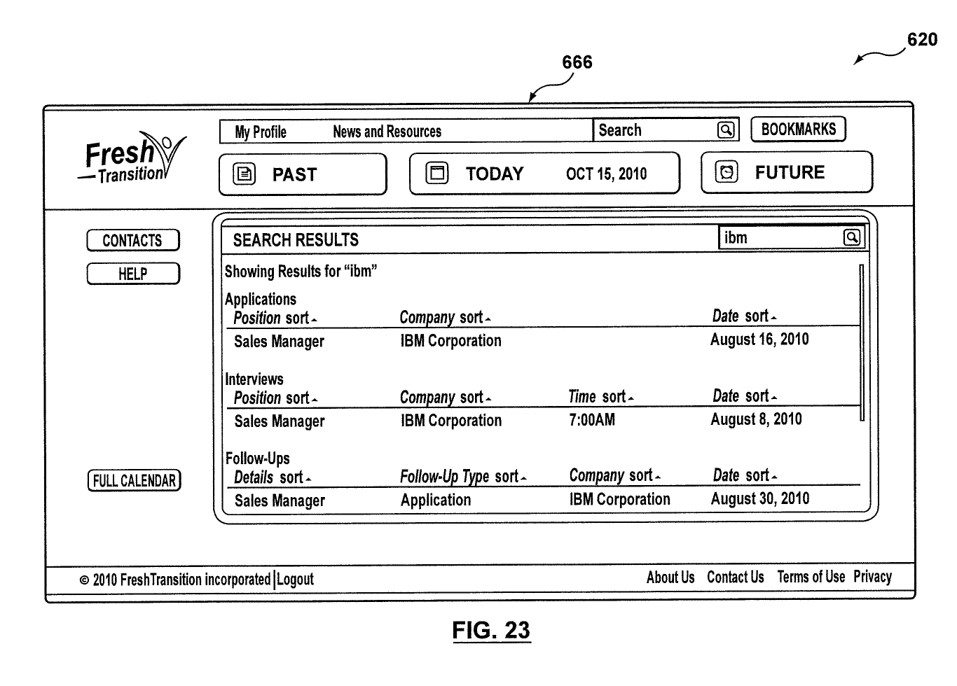

Referring to FIG. 23, shown there is an example Search Page 666 allowing searching of activities associated with job search data in an example user interface 620. The system can act as a job search data repository as it organizes and indexes all career search-related documents and data (including correspondences, cover letters, resumes, follow-up notes, and research), dates, times, and associated contacts, and automatically associates them with the relevant job search activity or event undertaken or scheduled to be completed (including job applications, job interviews, job search networking activities, meetings, follow-up activities, calendar entries and pending reminders). In doing so, the system can provide users with the ability to immediately recall or request all the information or data associated with any event, activity or document that has been recorded in the system.

The job search system 500 enables job seekers to search all previous job search data and activities recorded stored within the database on the job search system 500, as well as any pending job search data scheduled within the system by using keyword search functionality.

The database enables job seekers to quickly search for details stored in any job application, networking, interview, personal meeting, or follow-up record that has been stored in or automatically created by the system.

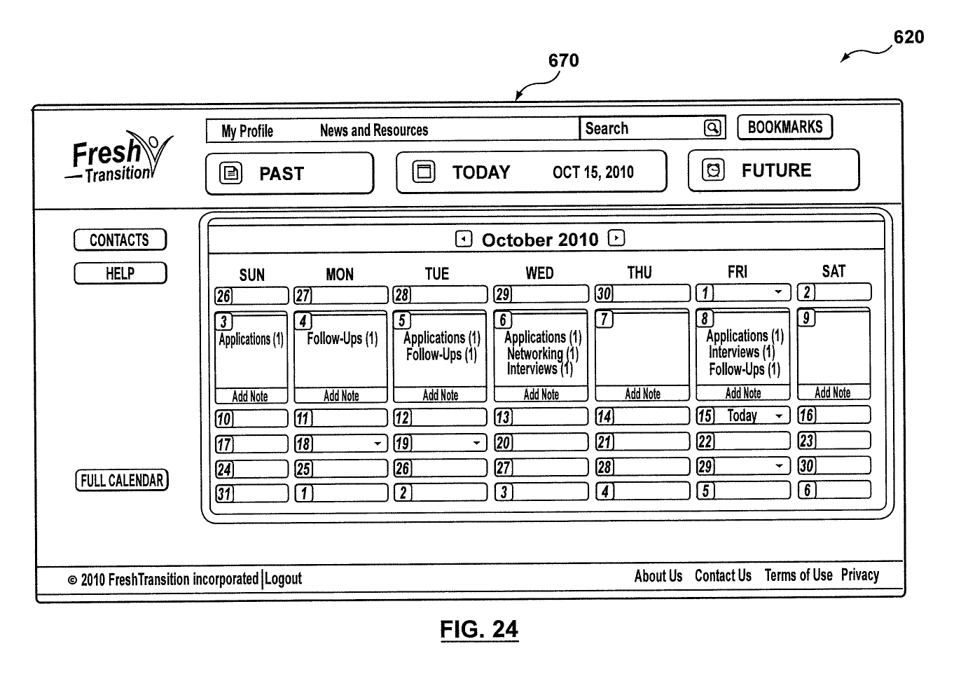

Referring to FIG. 24, shown there is an example Calendar Page 670 in an example user interface 620. The job search system 500 may contain a calendar that is automatically populated, for example, according to method 196, with the details of any activities completed, recorded, or scheduled for completion on any particular day, including job applications, job application follow-ups, networking events, networking event follow-ups, interviews, interview follow-ups, personal meetings resulting from networking events, personal meeting follow-ups. The content of the calendar is dynamic and enables job seekers to link to the details of any activities listed on the calendar by clicking on the activity listed in the calendar.

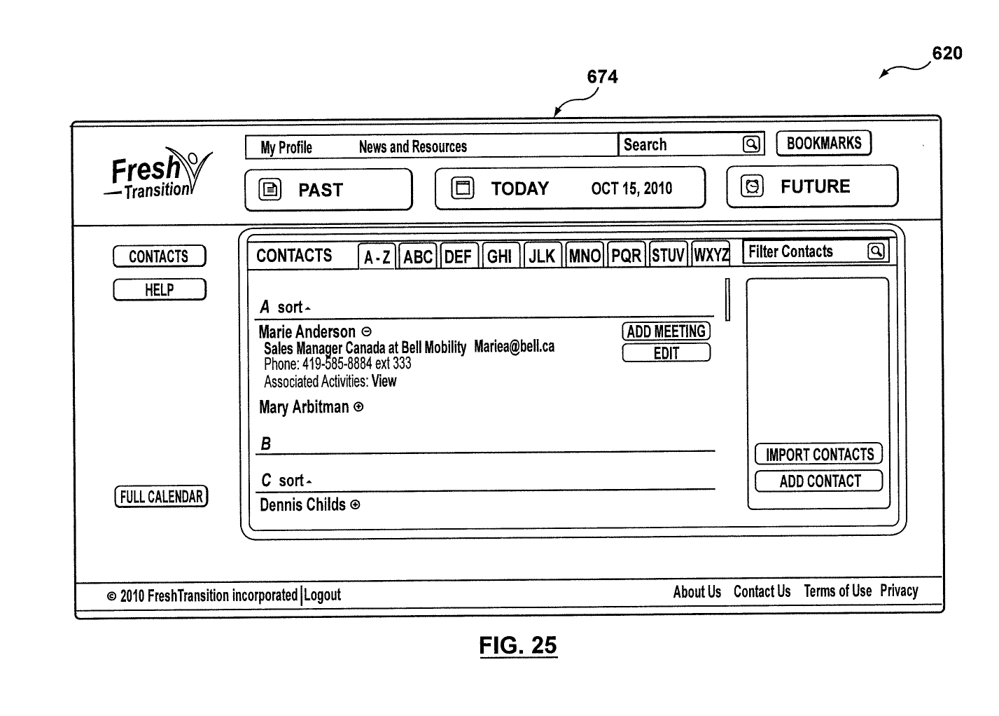

Referring to FIG. 25, shown there is an example Contact List Page 674 that can be populated, for example, according to methods 120 and 140, with job search data in an example user interface 620. The database of the job search system 500 may be configured to store contacts that are automatically populated with the details of any individuals identified as contacts within a job application, networking event, interview, or personal meeting. The contact list stores contact's name, employer, contact's position, contact's phone number, and contact's email, and links to any other activities associated with that particular contact.

Contacts can also be added to the contact manually by the job seeker 512 or can be imported from popular email and software applications such as Microsoft Outlook and Google's Gmail.

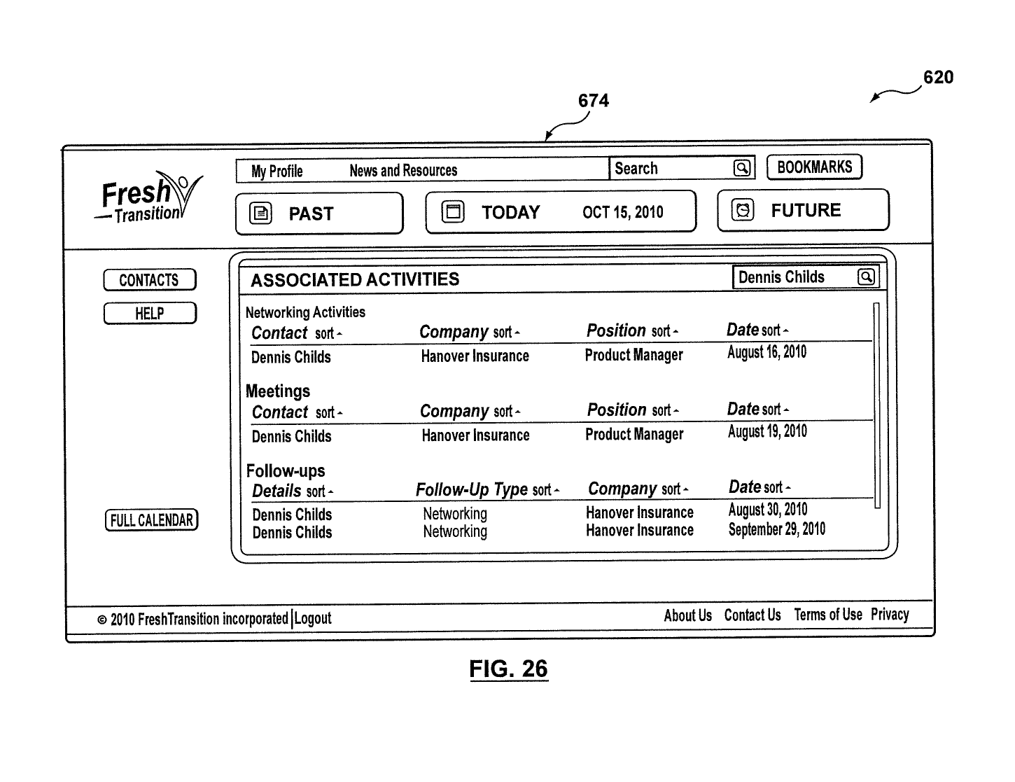

Referring to FIG. 26, shown there is an illustration of a Contact List Page 674 and a search of the activities associated with a particular contact in an example user interface 620. As illustrated, it can be seen that the content of the contact list can be dynamic so as to enable job seekers to retrieve any job search data or activities stored within the system that are associated with a particular contact.

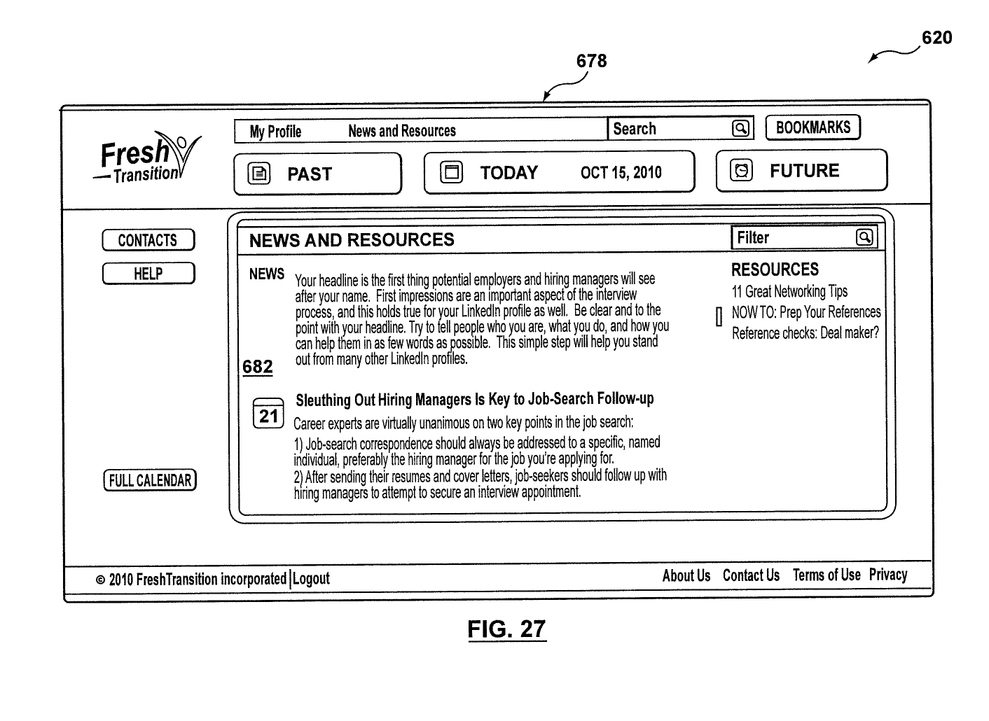

Referring to FIG. 27, shown there is an illustration of an example News and Resources Page 678 of an example user interface 620. In one embodiment, some or all of the pages on the system contain a link to a page that displays news and information that is of a relevant nature to the job seeker 512. News that appears on this page is dynamic and can be published to job seekers by the job seeker's group administrator or by the master administrator.

In various embodiments, some or all of the pages on the system contain a link to a page that displays resources that are relevant to the job seeker 512. The Resources section 682 contains dynamic content and can be published to job seekers by the job seeker's group administrator or by the master administrator. The resources may include, but are not limited to, links to document templates (samples of cover letters, resumes, correspondences, etc.), links to external service providers (resume writers, career coaches, mentors, etc.), and links to the system's library of streaming videos and webinars with tutorials, tips, motivational discussion, expert advice, and other job search relevant content.

As discussed above, the group administrator may be any third party 516 interested in monitoring the progress of the job seeker 512. As such, the resources provided on the resources page may be configured to correspond to the type of data that the interested third party 516 may provide. For example, if the third party 516 is a government agency, it may provide resources to specific government webpages indicating benefits eligibility information. If the third party 516 is an educational institution, the resources page may direct a job seeker 512 to an intranet job board provided only to students of the education institution (e.g., as may be the case if the student is using the job search system 500 as a part of a co-operative education program).

Access to the news and resources content management and reporting functionality by third party group 516 administrators, the master administrator occurs can occur over a network through the administrator's portal. As all job seeker data is segmented by user group, group administrators may be limited to only accessing the job seeker data associated with job seekers in their user group. As well, user group administrators can access a content management system through the administrator's portal, and can use this content management system to publish content to only job seekers within their user group.

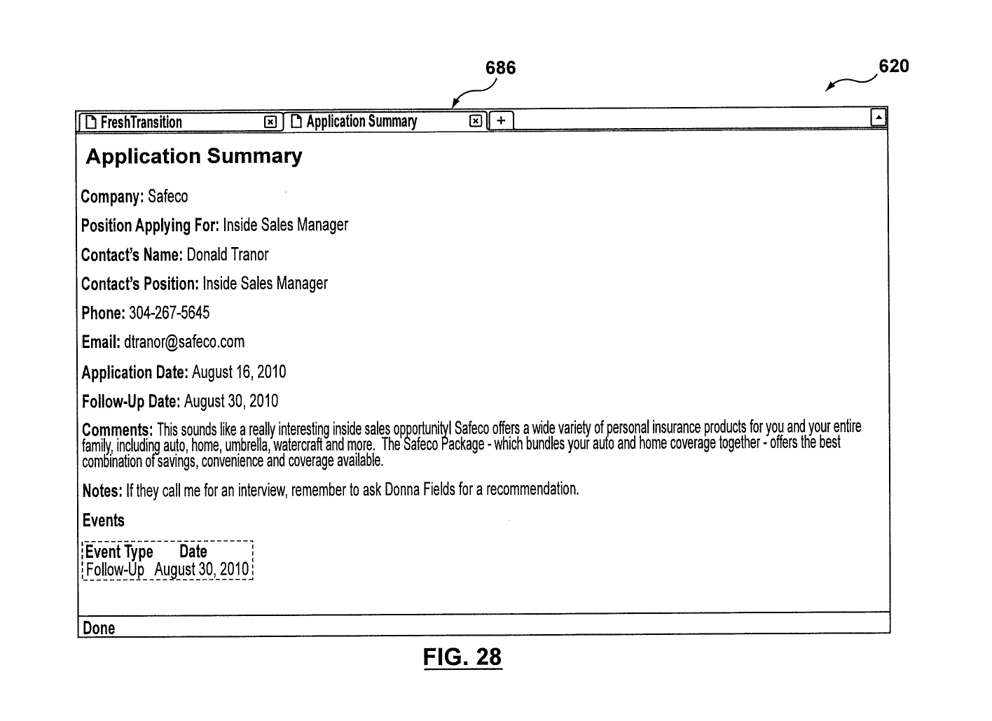

Referring to FIG. 28, there is shown an illustration of an example Summary Page 686 of job search data in an example user interface 620. In preparation for an interview or personal meeting, a job seeker 512 can click on the “Create a Summary” link within any Job Application or Networking record, and the system can generate a one-page printable summary of all the pertinent details relating to the Job Application or Networking event, as well as all the associated contact names, dates, and other activities associated with the original event (such as related interviews or personal meetings, and any associated follow-up activities).

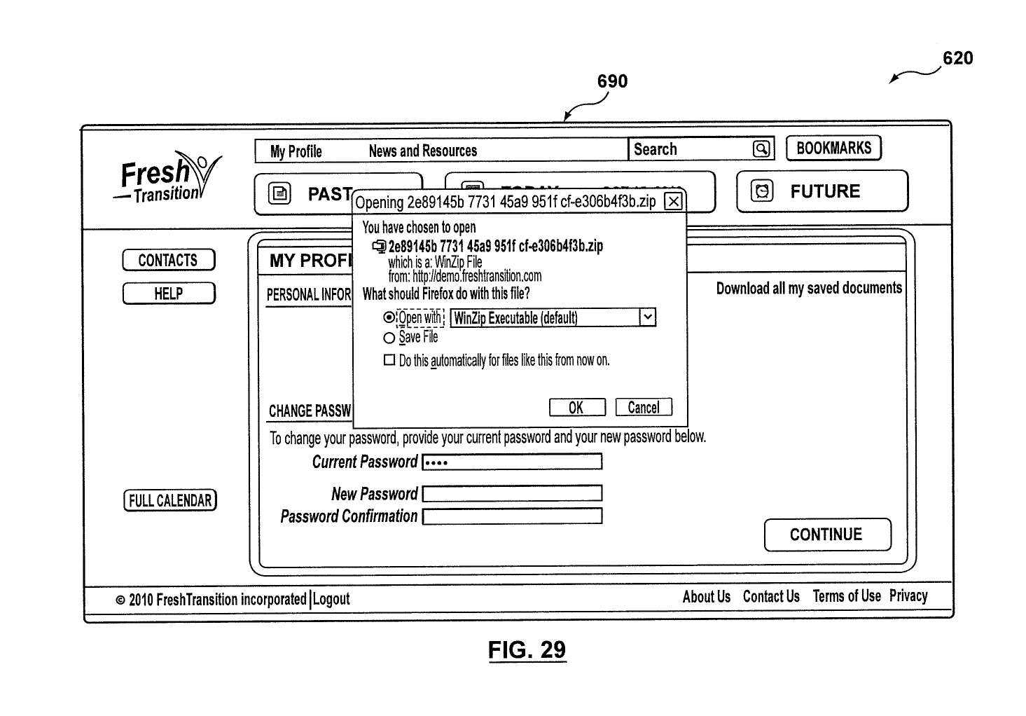

Referring to FIG. 29, there is shown an illustration of an example screenshot for downloading all documents 690 for a job seeker 512 in an example user interface 620. If at any time the job seeker 512 wishes to retrieve all the documents that he/she has stored in the system, the job seeker 512 can click on the “Download all my saved documents” link on the Profile page. In doing so, the job seeker 512 may be able to download a hierarchically organized “zip” file that contains all the documents that he/she has stored or uploaded into the system.

Referring to FIG. 30 shown there is a flowchart diagram 694 illustrating example steps performed by the system when creating a profile. Job seekers using the job search system 500 can access the job search system 500 enrollment page (and/or Home page) via a standard internet connection.

Upon logging in the first time, the job seeker 512 may be asked to provide a Yes or No response to whether their search will include applying to job applications at step 698, and whether their search will include networking events at step 702.

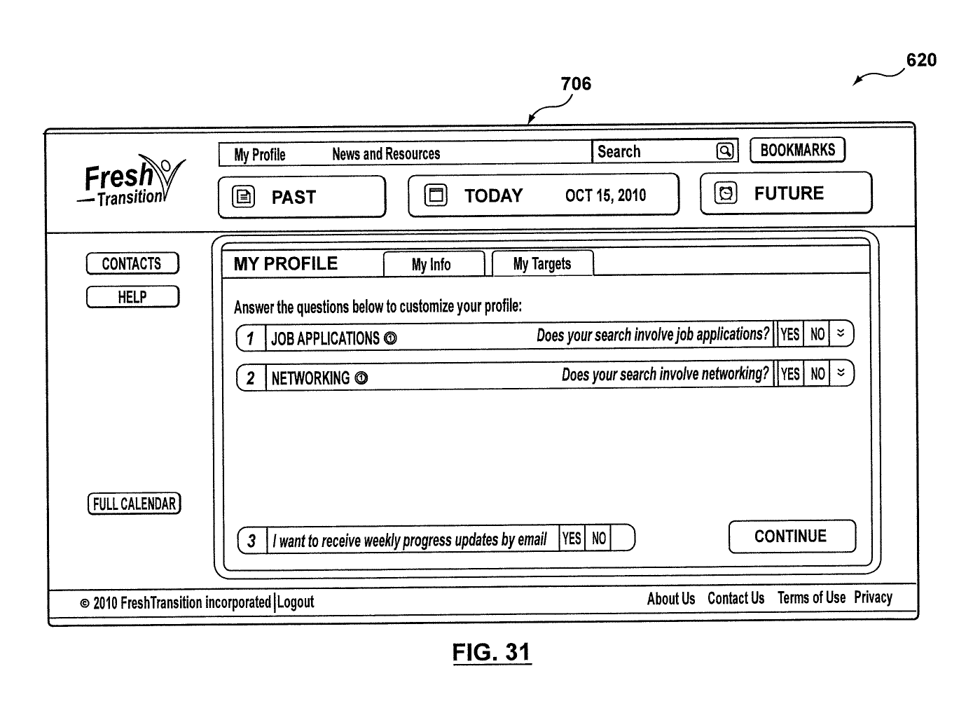

Referring to FIG. 31, shown there is an illustration of the options of Job Applications and/or Networking Page 706 in the first step of creating a new profile in an example user interface 620.

If the job seeker 512 confirms that their search will include applying to job applications, they are asked to set a daily or weekly job application target, a job application follow-up target, and a job application interview follow-up target.

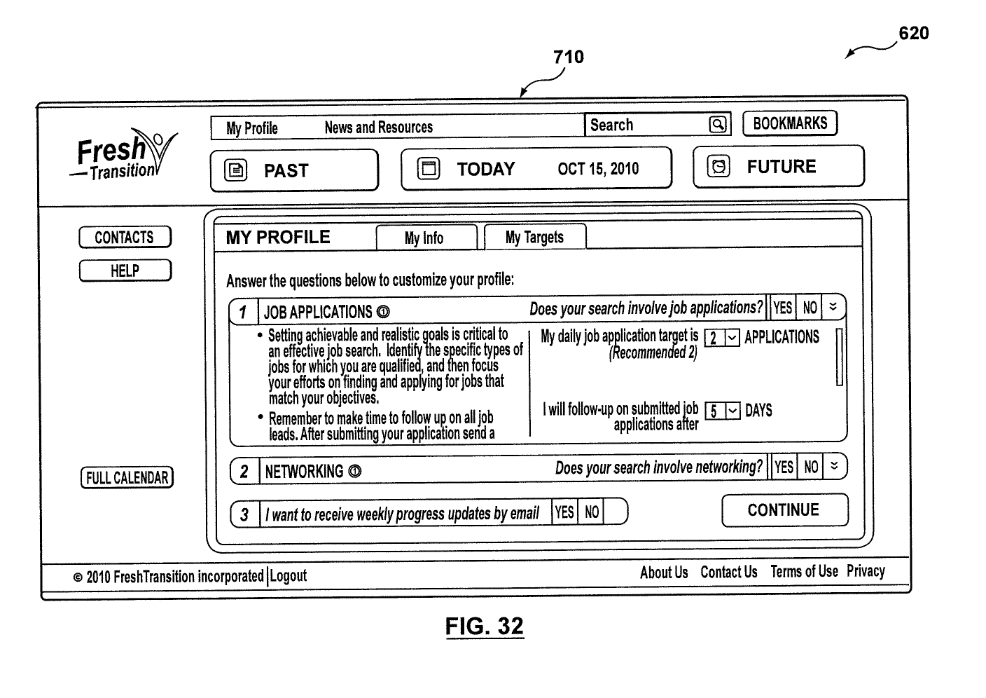

Referring to FIG. 32, shown there is an illustration of a setting Job Application targets page 710 when creating a new profile in an example user interface 620.

If the job seeker 512 confirms that their search will include networking events, they are asked to set a daily or weekly networking event target, a networking event follow-up target, and a personal meeting follow-up target.

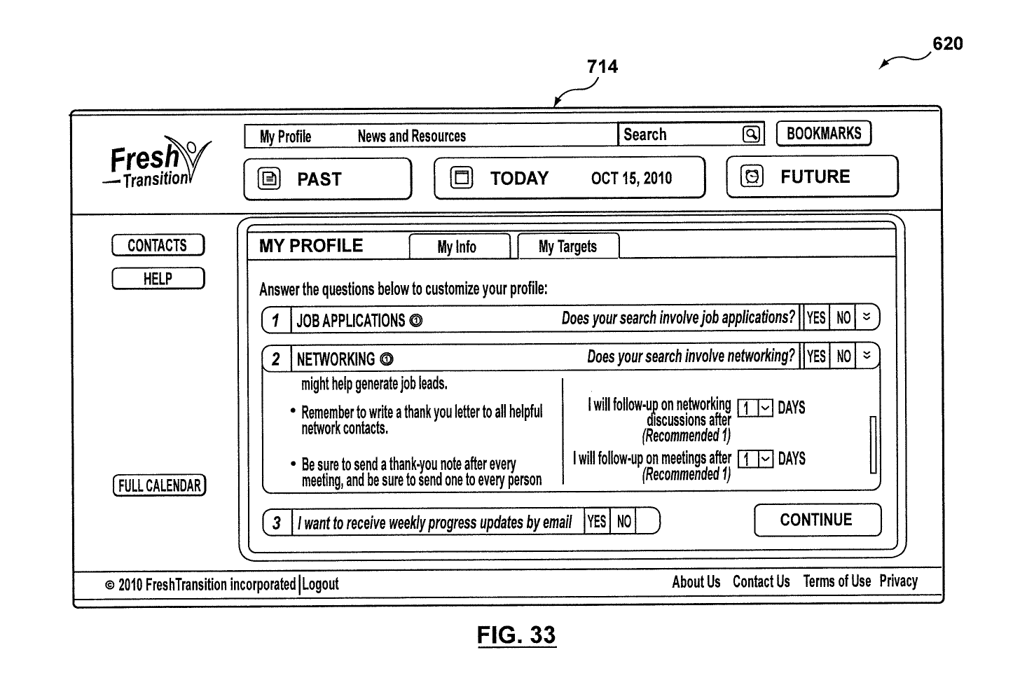

Referring to FIG. 33, shown there is an illustration of a setting Networking targets page 714 when creating a new profile in a user interface 620.

Upon completion of a job seeker's job search, the job seeker 512 may choose to use functionality that triggers the creation of a customized communication to the individuals contained within the job seekers contact list or a user-determined subset of these individuals. An email can be created that informs the selected group of individuals of the details of the job seeker's new role and thanks them for their support, contributions and/or other specific messaging as dictated by the job seeker 512.

Further, by closing the job seeker's job search, the job search system 500 triggers a timestamp that identifies the length of time between enrollment in the system and closure of the job search for archival and reference purposes. Such length of time may also be provided in a report to interested third parties 516 who are monitoring the job seeker 512.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A server for managing data representing a job search project comprising:
a memory for storing a master dataset representing said job search project; said master dataset comprising a plurality of records, each of said records belonging to a category and including a task identifier;
a processor connected to the memory, said processor configured to receive said master dataset from said memory;
said processor further configured to determine a first dataset comprising a portion of said records belonging to a first category, a second dataset comprising a portion of said records belonging to a second category and a third dataset comprising a portion of said records belonging to a third category; and
said processor further configured to generate an output signal for controlling: a first region of a computer display for generating a first dataset graphical interface, a second region of said computer display for generating a second dataset graphical interface and a third region of said computer display for generating a third dataset graphical interface.

2. The server of claim 1 wherein said first category is defined by a record status of complete inactive, said second category is defined by a record status of complete active or incomplete active and said third category is defined by a record status of incomplete inactive.

3. The server of claim 1 wherein said processor is further enabled to:
assign a time to an editable data field for each record;
determine a time window;
compare said time to said time window for each record; and
assign a record to said first category when said time is earlier than said time window;
assign a record to said second category when said time is during said time window; and
assign a record to said third category when said time is later than said time window.

4. The server of claim 3 wherein the time window comprises a current date.

5. The server of claim 1 further comprising at least one additional category.

6. The server of claim 1 wherein the processor is further configured to receive an instruction to change a category of a selected record within said second dataset to said first category and move said selected record to said first dataset.

7. The server of claim 6 wherein the processor is further configured to change a category of a connected record within said third dataset and associated with said selected record to said second category; and move said connected record to said second dataset.

8. The server of claim 1 wherein said first dataset represents past activities relating to said job search project; said second dataset represents current activities relating to said job search project; said third dataset represents future activities relating to said job search project.

9. The server of claim 1 further comprising automatically setting said category based on a reference time.

10. The server of claim 1 further comprising a display.

11. The server of claim 10 further comprising a network interface for sending said signal to a display via a network.

12. A computer-implemented method for managing data representing a job search project comprising:
receiving a master dataset representing said job search project; said master dataset comprising a plurality of records, each of said records belonging to a category and including a task identifier and at least one editable data field;
determining a first dataset comprising a portion of said records belonging to a first category;
determining a second dataset comprising a portion of said records belonging to a second category;
determining a third dataset comprising a portion of said records belonging to a third category;
controlling a first region of a computer display for generating a first dataset graphical interface;
controlling a second region of said computer display for generating a second dataset graphical interface; and,
controlling a third region of said computer display for generating a third dataset graphical interface.

13. The computer-implemented method of claim 12 wherein said first category is defined by a record status of complete inactive, said second category is defined by a record status of complete active or incomplete active and said third category is defined by a record status of incomplete inactive.

14. The computer-implemented method of claim 12 further comprising:
assigning a time to an editable data field for each record;
determining a time window;
comparing said time to said time window for each record; and
assigning a record to said first category when said time is earlier than said time window;
assigning a record to said second category when said time is during to said time window; and
assigning a record to said third category when said time is later than said time window.

15. The computer-implemented method of claim 14 wherein the time window comprises a current date.

16. The computer-implemented method of claim 12 further comprising at least one additional category.

17. The computer-implemented method of claim 12 further comprising receiving an instruction to change a category of a selected record within said second dataset to said first category and moving said selected record to said first dataset.

18. The computer-implemented method of claim 17 further comprising changing a category of a connected record within said third dataset and associated with said selected record to said second category; and moving said connected record to said second dataset.

19. The computer-implemented method of claim 12 wherein said first dataset represents past activities relating to said job search project; said second dataset represents current activities relating to said job search project; said third dataset represents future activities relating to said job search project.

20. The computer-implemented method of claim 12 further comprising automatically setting said category based on a reference time.
